(19) United States
(12) Patent Application Publication
(10) Pub. No.: US 2018/0224579 A1
(43) Pub. Date: Aug. 9, 2018

(54) ANTIREFLECTION FILM, MANUFACTURING METHOD OF ANTIREFLECTION FILM, KIT INCLUDING ANTIREFLECTION FILM AND CLEANING CLOTH

(71) Applicant: FUJIFILM Corporation, Tokyo (JP)

(72) Inventors: Shuntaro IBUKI, Kanagawa (JP); Yutaka ADEGAWA, Kanagawa (JP)

(73) Assignee: FUJIFILM Corporation, Tokyo (JP)

(21) Appl. No.: 15/944,173

(22) Filed: Apr. 3, 2018

Related U.S. Application Data
(62) Division of application No. 14/869,252, filed on Sep. 29, 2015.

(30) Foreign Application Priority Data
Sep. 30, 2014 (JP) 2014-200054

(51) Int. Cl. G02B 1/118

(52) U.S. Cl. CPC G02B 1/118; B08B 1/006

(57) ABSTRACT

There is provided an antireflection film including an unevenness structure having an average cycle shorter than a visible light wavelength on a transparent substrate film, wherein in the unevenness structure, an average aspect ratio of an average height of convex portions or an average depth of concave portions to an average cycle is from 1.0 to 3.0, a water contact angle to an unevenness structure surface is 100° or more, and a specular reflectance is 2.0% or less.

### CROSS REFERENCE TO RELATED APPLICATION(S)

The present application is a Divisional Application of U.S. patent application Ser. No. 14/869,252, which was filed Sep. 29, 2015, and which claims priority from Japanese Patent Application No. 2014-200054 filed on Sep. 30, 2014, the entire disclosures of all of which are incorporated herein by reference.

### BACKGROUND

### 1. Technical Field

The present invention relates to an antireflection film, a manufacturing method of the antireflection film, and a kit including the antireflection film and a cleaning cloth.

### 2. Background Art

In an image display device such as a cathode ray tube display (CRT), a plasma display (PDP), an electroluminescence display (ELD), a fluorescent display (VFD), a field emission display (FED) or a liquid crystal display device (LCD), an antireflection film may be provided in order to prevent contrast reduction or image reflection caused by reflection of external light on the display surface. Also, in, for example, a lens, a meter front cover, a headlight cover, a head-up display (HUD), a window plate, and a show window, an anti-reflective property of light and a high light transparency have been gradually required.

As for an antireflection film, an antireflection film having a fine unevenness shape having a cycle not longer than a visible light wavelength on a transparent substrate film surface, that is, an antireflection film having a so-called moth-eye structure has been known. By the moth-eye structure, a refractive index gradient layer in which a refractive index is continuously varied from air toward the bulk material inside the transparent substrate film is artificially, so that reflection of light may be prevented.

As a method of imparting an antifouling property to the antireflection film having a microstructure on the surface thereof, a method of imparting hydrophilicity to the surface has been suggested (International Publication Pamphlet No. 2012/157717, hereinafter WO 2012/157717).

The antireflection film having a moth-eye structure has a problem in relation to material deposition (hereinafter referred to as dirt) in that when a material having a different refractive index from air is present in the unevenness structure, a reflectance is increased in only the portion of the material, thereby significantly impairing the visibility.

In the hydrophilization method of WO 2012/157717, dirt itself is water-soluble or contains water. That is, before the water is dried, the dirt can be removed. Thus, it may be said that an antifouling property is imparted. However, in actual use, in many cases, the dirt itself may be oil-based dirt insoluble in water, and even if the dirt itself is water-soluble, the dirt may be recognized, and cleaning is required. Thus, it cannot be said that the antifouling property is imparted in the true sense. Therefore, providing of a water repellent antifouling property to the antireflection film having a moth-eye structure on the surface thereof has been an ongoing challenge.

An object of the present invention is to provide an antireflection film having a water repellent moth-eye structure which has a low reflectance, and an excellent antifouling property. Also, an object of the present invention is to provide a manufacturing method of the antireflection film, and a kit including the antireflection film and a cleaning cloth.

The present inventors have intensively studied and found that the above-mentioned problems may be solved by the following means.

### SUMMARY

[1] An antireflection film including an unevenness structure having an average cycle shorter than a visible light wavelength on a transparent substrate film, wherein in the unevenness structure, an average aspect ratio of an average height of convex portions or an average depth of concave portions to an average cycle is from 1.0 to 3.0, a water contact angle to an unevenness structure surface is 100° or more, and a specular reflectance is 2.0% or less.

[2] The antireflection film according to[1], including an antifouling layer in a region of the unevenness structure in a range of 0.1 nm to 5 nm from the unevenness structure surface toward the transparent substrate film side, wherein a content ratio of fluorine atoms to oxygen atoms in the antifouling layer is from 1.0 to 5.0, or a content ratio of silicon atoms derived from a silicone structure to oxygen atoms in the antifouling layer is from 1.0 to 5.0.

[3] The antireflection film according to [1], including an antifouling layer in a region of the unevenness structure in a range of 0.1 nm to 5 nm from the unevenness structure surface toward the transparent substrate film side,

wherein a content ratio of fluorine atoms to carbon atoms in the antifouling layer is from 0.2 to 1.0, or a content ratio of silicon atoms derived from a silicone structure to carbon atoms in the antifouling layer is from 0.2 to 1.0.

[4] The antireflection film according to [1] or [2], further including silica fine particles on the unevenness structure surface, in which a modification rate of a hydrophobic modification is 30% or less, and an average primary particle diameter is 20 nm or less.

[5] A method of manufacturing an antireflection film according to [2], including: preparing an unevenness structure with an average cycle shorter than a visible light wavelength by fully curing a curable composition, in which in the unevenness structure, an average aspect ratio of an average height of convex portions or an average depth of concave portions to the average cycle is from 1.0 to 3.0; and laminating an antifouling layer with a film thickness ranging from 0.1 nm to 5 nm through an atmospheric pressure plasma treatment.

[6] A method of manufacturing an antireflection film of [3], including:

preparing an unevenness structure with an average cycle shorter than a visible light wavelength by semi-curing a curable composition, in which in the unevenness structure, an average aspect ratio of an average height of convex portions or an average depth of concave portions to the average cycle is from 1.1 to 3.5;

laminating an antifouling layer with a film thickness ranging from 0.1 nm to 5 nm through one selected from the group consisting of a die coater coating, a spray coating, a dip coating and an inkjet coating; and fully curing the curable composition.

[7] A kit including:

an antireflection film according to any one of [1] to [4]; and

a cleaning cloth having a void or hole with a smaller interval than an average cycle of an unevenness structure of the antireflection film according to any one of [1] to [4], in which a water contact angle of the cleaning cloth is less than 90°.

According to an aspect of the present invention, it is possible to provide an antireflection film having a water repellent moth-eye structure which has a low reflectance, and an excellent antifouling property. Also, according to another aspect of the present invention, it is possible to provide a manufacturing method of the antireflection film, and a kit including the antireflection film and a cleaning cloth. According to the kit including the antireflection film and the cleaning cloth, in the present invention, the antireflection film may be cleaned with the cleaning cloth, so that dirt of the antireflection film having the moth-eye structure may be conveniently removed.

### BRIEF DESCRIPTION OF DRAWINGS

FIG. 1 is a schematic view of an exemplary apparatus for continuously manufacturing an antireflection film having a moth-eye structure.

### DETAILED DESCRIPTION OF EXEMPLARY EMBODIMENTS

Hereinafter, features of the present invention will be described in detail. Meanwhile, in the present specification, “to” is used in a sense including numerical values described before and after it, as a lower limit and an upper limit. Also, in the present specification, “(meth)acrylate” indicates “acrylate” or “methacrylate.” A polymerizable monomer in the present invention is distinguished from an oligomer and a polymer, and is a compound having a weight average molecular weight of 1,000 or less. In the present specification, a “polymerizable group” refers to a group that contributes to the polymerization. “imprint” and “fine pattern” referred to in the present invention refer to preferably a pattern transfer or a pattern transcript with a size ranging from 1 nm to 10 mm, and more preferably to a pattern transfer or a pattern transcript with a size ranging from about 10 nm to 100 μm (nano imprint).

[Antireflection Film]

The antireflection film of the present invention is an antireflection film having an unevenness structure with an average cycle shorter than a visible light wavelength on a transparent substrate film. The unevenness structure has an average aspect ratio represented by a ratio of an average height of convex portions or an average depth of concave portions to an average cycle, ranging from 1.0 to 3.0, a water contact angle to the unevenness structure surface of 100° or more, and a specular reflectance if 2.0% or less.

The antireflection film of the present invention has an unevenness structure with an average cycle shorter than a visible light wavelength, that is, a so-called moth-eye structure. Also, in the present invention, the unevenness structure has the average aspect ratio ranging from 1.0 to 3.0 in which the average aspect ratio is represented by a ratio of an average height of convex portions or an average depth of concave portions to the average cycle.

More specifically, the unevenness structure preferably has convex portions having an average height ranging from 100 nm to 1000 nm or concave portions having an average depth ranging from 100 nm to 1000 nm. Herein, convex portions refer to portions protruding from a reference surface, and concave portions refer to portions dented from the reference surface. The antireflection film having the unevenness structure of the present invention may have convex portions or concave portions on the surface thereof. Also, the antireflection film may have both the convex portions and the concave portions, and further have a wavy structure in which the convex portions and the concave portions are connected to each other.

The presence or absence of the unevenness structure may be confirmed by observing a surface shape through, for example, a scanning electron microscope (SEM) or an atomic force microscope (AFM).

Above all, it is preferred that the convex portions or concave portions are included in the outermost surface of the antireflection film in contact with air. Since air has a refractive index largely different from that of the antireflection film of the present invention, an antireflection performance and a light transparency improvement performance may be favorably exhibited when an interface of materials having different refractive indexes includes a specific unevenness structure of the present invention. Also, when the unevenness structure of the present invention is present on the outermost surface on which dirt is likely to be adhered, the effect of the present invention may be exhibited, and for example, an antifouling property may be improved.

It is preferable that the convex portions or concave portions are uniformly present on the whole of at least one surface of the antireflection film in order to exhibit the effect. In a case of convex portions, the average height from the reference surface preferably ranges from 100 nm to 1000 nm, also, in a case of concave portions as well, the average depth from the reference surface preferably ranges from 100 nm to 1000 nm. Heights or depths may not be constant as long as their average value falls within the range described above. However, it is preferred that heights or depths are substantially constant.

In a case of concave portions as well as convex portions, the average height or average depth is more preferably 120 nm or more, and particularly preferably 150 nm or more. Also, the upper limit is more preferably 700 nm, still more preferably 500 nm, and particularly preferably 350 nm. When the average height or the average depth is too small, a good optical property may not be exhibited, while when it is too large, there may be difficulties in manufacturing.

According to presence of convex portions or presence of concave portions on the whole of the surface of the antireflection film, the location of the reference surface is set to a surface formed with substantially the deepest portion, or a surface formed with substantially the topmost portion. Then, in the scope of the present invention, an average length from the topmost portion to the deepest portion preferably ranges from 100 nm to 1000 nm, more preferably from 120 nm to 700 nm, still more preferably from 150 nm to 500 nm, and particularly preferably from 150 nm to 350 nm due to the reasons described above.

Preferably, in the antireflection film of the present invention, on the surface, the convex portions or the concave portions are present at an average cycle ranging from 50 nm to 400 nm in at least one certain direction. The convex portions or concave portions may be randomly arranged, or regularly arranged. A distance between apexes of adjacent convex portions is set as a distance between convex portions, and an average of the respective distance between convex portions is set as an average cycle. Likewise, in a case where concave portions are mainly present, a distance between the deepest portions of adjacent concave portions is set as a distance between concave portions, and an average of the respective distance between concave portions is set as an average cycle. In any case, it is preferred that the convex portions or concave portions are substantially uniformly arranged on the surface of the antireflection film having an unevenness structure in view of an antireflection property or a light transparency improvement.

When the convex portions or concave portions are regularly arranged, preferably an average cycle in at least one direction ranges from 50 nm to 400 nm as described above. It is further preferable that the arrangement is made such that a cycle in a direction having the shortest cycle (hereinafter, referred to as “x-axis direction”) ranges from 50 nm to 400 nm.

The average cycle (“cycle” when there is a regularity in the arrangement location of convex portions or concave portions) is preferably 70 nm or more, more preferably 100 nm or more, particularly preferably 120 nm or more, and still more preferably 150 nm or more. Also, it is preferably 300 nm or less, more preferably 250 nm or less, and particularly preferably 200 nm or less. When the average cycle is too short or too long, the antireflection effect may not be sufficiently obtained.

The aspect ratio which is a value obtained by dividing an unevenness height or depth by an average cycle is preferably 1.0 or more in view of a reflectance reduction or a transmittance improvement, more preferably 1.5 or more, and particularly preferably 2.0 or more. Further, it is preferably 3.0 or less in view of a scratch resistance.

Meanwhile, as described below, since in a case where an antifouling layer is produced on an unevenness structure by wet coating, the aspect ratio tends to decrease due to the leveling of an antifouling layer binder during coating and drying. Thus, the aspect ratio before the antifouling layer is coated is preferably set to be a higher value in advance, that is, preferably 1.1 or more, more preferably 1.7 or more, and particularly preferably 2.2 or more. Further, likewise, it is preferably 3.5 or less in view of a manufacturing process of an antireflection film having an unevenness structure.

(Curable Composition)

When the antireflection film having an unevenness structure of the present invention, which has a specific surface structure as described above, is formed by the following material (a curable composition), the film is excellent in an optical performance such as an antireflection performance of light, a light transparency improvement performance of light, and particularly excellent in a mechanical strength such as a surface scratch resistance; and an antifouling property allowing dirt to be hardly attached or easily wiped through water-wiping.

That is, preferably, the antireflection film having an unevenness structure of the present invention is obtained by polymerizing a curable composition containing a polymerizable monomer.

The antireflection film having an unevenness structure of the present invention is obtained by polymerizing a curable composition containing a (meth)acrylate compound, and the (meth)acrylate compound particularly preferably contains polyethylene glycol di(meth) acrylate in an amount of 53% by mass or more based on the total amount of the (meth)acrylate compound. Hereinafter, a material for the antireflection film having an unevenness structure of the present invention will be described.

The antireflection film having an unevenness structure of the present invention is preferably formed by polymerizing the “curable composition containing a (meth)acrylate compound.” The “curable composition” preferably contains (a) a (meth)acrylate compound, and also contains (b) fine particles and (c) a polymerization initiator, and also, as necessary, preferably contains (d) a releasing agent, particularly a fluorine-based surfactant in order to exhibit the effect described above, and particularly preferably a fluorine-based surfactant having an alkylene oxide repeating structure and a fluoroalkyl group in order to exhibit the effect described above. It may further contain any optional components such as (e) an adhesion improver.

The “curable composition” may contain, for example, a binder polymer; an antioxidant; an UV absorber; a light stabilizer; a defoamer; a lubricant; and a levelling agent, in addition to the components described above. Some of components included in the curable composition may be only incorporated therein through polymerization of the (meth)acrylate compound, but themselves may not directly contribute to the polymerization.

In the present invention, it is preferred to form an unevenness structure by the curable composition using a mold.

It is preferred that the viscosity of the curable composition that may be used in the present invention is set to fall within the range of 3 mPa·s to 1000 mPa·s. In the present invention, a low viscosity composition is preferred in view of an accuracy improvement of an unevenness pattern formation and a mold releasing property improvement. Meanwhile, when the layer formed of the curable composition is larger than 3 μm, a high viscosity around 6 mPa·s to 1000 mPa·s is preferred. Generally, when the number of polymerizable functional groups of the polymerizable monomer is increased, the viscosity tends to increase, and the hardness after curing tends to increase. Also, by containing the fine particles, the viscosity tends to increase. In the present invention, it is preferred to use polymerizable monomers having different viscosities or different numbers of functional groups in combination so that a desired viscosity is obtained in consideration of the surface shape of a mold pattern or the frequency of unevenness, and a physical property such as elastic modulus required for a fine pattern after curing.

The antireflection film having an unevenness structure of the present invention may be formed by reaction of a double bond of carbon atoms in a (meth)acrylic group in the curable composition as a material for the film, through at least one of photo-irradiation, electron beam irradiation and heating. From a group consisting of photo-irradiation, electron beam irradiation and heating, any one treatment may be selected, two treatments may be selected and used in combination, or all of the three treatment may be used in combination. Above all, in view of a cost and prevalence of an irradiation device, a time required for curing (line speed) and the like, the curing (polymerization) is preferably performed by UV irradiation among photo-irradiation methods.

When an antifouling layer is laminated on the unevenness structure, the reaction rate of a double bond of carbon atoms in the (meth)acrylic group is preferably changed according to the kinds of the antifouling layer in order to contribute to the improvement of adhesion to the antifouling layer.

(A) When the antifouling layer is formed by atmospheric pressure plasma treatment to be described below, since the reaction rate does not significantly contribute to the impartment of an adhesion to the antifouling layer, the reaction rate is preferably “fully cured,” and is preferably 70% or more, more preferably 85% or more, and particularly preferably 90% or more based on the total of carbon-carbon double bonds. Here, the “reaction rate” is obtained by measuring, by an infrared spectroscopy (IR), specifically, attenuated total reflection method (ATR method) using a Fourier transform infrared spectrophotometer, Spectrum One D (manufactured by Perkin Elmer, Inc.), an absorbance at 1720 cm⁻¹ attributing to a carbon-oxygen bond in an ester bond and an absorbance at 811 cm⁻¹ attributing to a carbon-carbon bond contained in the (meth)acrylic curable composition before and after the reaction so as to obtain a ratio of their absorbance. When the reaction rate is too low, a reduction of a mechanical strength or a reduction of a chemical resistance may be caused.

(B) When the antifouling layer is formed by wet coating to be described below, since the reaction rate significantly contributes to the impartment of adhesion to the antifouling layer, the reaction rate is preferably “semi-cured,” and preferably ranges from 40% to 80%, and more preferably from 50% to 70%, based on the total of carbon-carbon double bonds. When the reaction rate is too low, an unreacted monomer is extracted with a solvent during the wet coating, thereby reducing a fluorine content of the antifouling layer, and reducing the water repellency. When the reaction rate is too high, the adhesion to the antifouling layer is reduced, thereby causing a reduction of a scratch resistance as well as antifouling durability.

(a) (Meth)Acrylate Compound

The curable composition in the present invention preferably contains a (meth)acrylate compound.

a-1-1. Polyethylene Glycol Di(Meth)Acrylate

The curable composition in the present invention preferably contains a (meth)acrylate compound, and the (meth)acrylate compound preferably contains polyethylene glycol di(meth)acrylate in an amount of 53% by mass or more based on the total amount of the (meth)acrylate compound. When the polyethylene glycol di(meth)acrylate is contained in an amount of 53% by mass or more based on the total amount of the (meth)acrylate compound, the affinity to a mold having an unevenness structure is high, so that the curable composition may easily enter the unevenness structure, the surface of the antireflection film is hardly scratched, and dirt is hardly attached or is easily wiped.

Also, a hydrophilicity is favorably imparted to the surface of the antireflection film having an unevenness structure which has the specific microstructure described above, and also even when the reaction rate of the carbon-carbon double bond, that is, the degree of polymerization is sufficiently increased, the storage elastic modulus at 25° C. and/or 180° C. may be likely to fall within a proper range. Accordingly, the resultant antireflection film having an unevenness structure is very excellent in an optical performance such as an antireflection performance of light, a light transparency improvement performance of light; a mechanical strength such as a surface scratch resistance; and a property allowing dirt to be hardly attached or easily wiped through water-wiping (hereinafter, also simply referred to as an antifouling property).

The polyethylene glycol di(meth)acrylate is preferably contained in an amount of 53% by mass or more based on the total amount of the (meth)acrylate compound, more preferably of 55% by mass or more, particularly preferably of 60% by mass or more, and still more preferably of 65% by mass or more. The upper limit is not particularly limited, but the content is preferably 95% by mass, particularly preferably 90% by mass, and still more preferably 85% by mass. When two or more kinds of the polyethylene glycol di(meth)acrylates are used, the range described above is a total amount of these.

When the content ratio of the polyethylene glycol di(meth)acrylate based on the total amount of the (meth)acrylate compound is too small, the hydrophilicity may not be favorably imparted to the surface having the specific microstructure in the resultant antireflection film, or the storage elastic modulus of the resultant antireflection film at 25° C. and/or 180° C. may not fall within the proper range. As a result, the mechanical strength such as a surface scratch resistance; and a property allowing dirt to be hardly attached or easily wiped through water-wiping (an antifouling property) may not be sufficiently achieved. Meanwhile, when the content ratio of the polyethylene glycol di(meth)acrylate is too large, such a content ratio is effective in improvement of a hydrophilic performance, or improvement of an antifouling property, but reduces the mechanical strength such as a surface scratch resistance in some cases.

The length of an ethylene glycol chain in the polyethylene glycol di(meth)acrylate is not particularly limited, but preferably ranges, when “—CH₂CH₂O—” is one unit, from 4 units to 40 units on average, more preferably from 6 units to 32 units, particularly preferably from 8 units to 25 units, and still more preferably from 12 units to 20 units. Here, the number of the units is represented by “n” in Formula (1) described below. When the ethylene glycol chain is too short or too long, the hydrophilicity may not be favorably imparted to the surface of the antireflection film having an unevenness structure.

When the ethylene glycol chain is too short, the storage elastic modulus at 25° C. may become too large, or the hydrophilicity may not be imparted (the contact angle may become too large). When the chain is too long, the curability may become poor, the storage elastic modulus at 25° C. may become too small, or the low temperature stability may be deteriorated, thereby causing crystallization. As a result, when the ethylene glycol chain is too short or too long, a mechanical strength such as a surface scratch resistance; and an antifouling property allowing dirt to be hardly attached or easily wiped through water-wiping may not be sufficiently achieved, and thus may not be highly excellent.

When the polyethylene glycol di(meth)acrylate is represented by Formula (1) below, the effects above may be significantly exhibited.

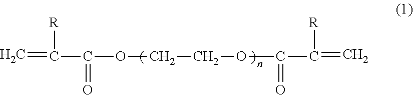

In Formula (1), R represents a hydrogen atom or a methyl group, and n represents the number of repeating units, in a range of 4 to 40 on average.

The polyethylene glycol di(meth)acrylate may be used alone or two or more kinds of polyethylene glycol di(meth)acrylates having different numbers of (repeating) units may be used in combination. In the use of two or more kinds, the total amount is preferably 53% by mass or more.

Any of a (meth)acrylate compound, and polyethylene glycol di(meth)acrylate included in the compound may be acrylate or methacrylate, but acrylate is preferred in view of good polymerizability, and easiness of adjusting a mechanical strength of a cured film.

In the present invention, the (meth)acrylate compound may include polypropyleneglycol di(meth)acrylate, but polyethylene glycol di(meth)acrylate is significantly excellent in the above described performances as compared to polypropyleneglycol di(meth)acrylate.

In the present invention, the curable composition may further contain the fluorine-based surfactant to be described below, particularly, a “fluorine-based surfactant having an alkylene oxide repeating structure and a fluoroalkyl group.” Thus, due to synergy between polyethylene glycol di(meth)acrylate and the fluorine-based surfactant, significant effects may be achieved such that particularly, scratch hardly occurs on the surface of the antireflection film having an unevenness structure, and particularly, dirt is hardly attached or is easily wiped.

As for the polyethylene glycol di(meth)acrylate, specifically, for example, ethylene glycol di(meth)acrylates such as diethyleneglycol di(meth)acrylate, triethyleneglycol di(meth)acrylate, tetraethyleneglycol di(meth)acrylate, polyethylene glycol#200di(meth)acrylate, polyethylene glycol#400di(meth)acrylate, polyethylene glycol#600di(meth)acrylate, polyethylene glycol#1000di(meth)acrylate, polyethylene glycol#1200di(meth)acrylate, polyethylene glycol#1540di(meth)acrylate, and polyethylene glycol#2000di(meth)acrylate may be exemplified.

Also, the specific examples are not limited to “#200”, “#400”, “#600”, “#1000”, “#1200”, “#1540” and “#2000” described above, but may include polyethylene glycol di(meth)acrylates in a range of #200 to #2000.

Here, for example, “#200” is related to the number of the repeating units of a polyethylene glycol chain, and when “—CH₂CH₂O—” is one unit, “#200” indicates 4 units, “#400” indicates 8 units, “#600” indicates 12 units, “#1000” indicates 20 units, “#1540” indicates 32 units, and “#2000” indicates 40 units.

a-1-2. Urethane(Meth)Acrylate

The (meth)acrylate compound in the present invention preferably further contains urethane(meth)acrylate. The “urethane(meth)acrylate” refers to a (meth)acrylate compound having a urethane bond in a molecule.

The urethane(meth)acrylate used in the present invention is not particularly limited. For example, the position or the number of urethane bonds, and the position or the number of (meth)acrylic groups are not particularly limited.

As for a preferred chemical structure of the urethane(meth)acrylate used for forming the antireflection film having an unevenness structure of the present invention, a chemical structure which has (A) a structure obtained by reacting a compound having (preferably a plurality of) isocyanate groups in the molecule, with a compound having a hydroxyl group and (preferably a plurality of) (meth)acrylic groups in the molecule, or (B) a structure obtained by reacting a compound having a hydroxyl group and a (meth)acrylic group in the molecule such as hydroxyethyl(meth)acrylate, with an unreacted isocyanate group of a compound obtained by reacting a compound having a plurality of hydroxyl groups with a diisocyanate compound or a triisocyanate compound may be exemplified.

When the (meth)acrylate compound contains the urethane(meth)acrylate, the curability and reaction rate are increased, so that the storage elastic modulus of the resultant antireflection film having an unevenness structure at 25° C. and/or 180° C. may fall within a preferred range. Also, the flexibility of the resultant antireflection film having an unevenness structure becomes excellent, and thus, for example, a mechanical strength such as a surface scratch resistance, and an antifouling property may be sufficiently achieved.

As for the urethane(meth)acrylate, tri- or polyfunctional urethane(meth)acrylate, or bi- or monofunctional urethane(meth)acrylate may be properly used. Also, the urethane(meth)acrylate may be used alone or two or more kinds thereof may be used in combination. The chemical structure of such a urethane(meth)acrylate is not particularly limited, and the weight average molecular weight preferably ranges from 1000 to 30000, more preferably from 1500 to 15000, and particularly from 2000 to 5000. When the molecular weight is too small, the flexibility may be reduced.

[Tri- or Polyfunctional Urethane(Meth)Acrylate]

As for the urethane(meth)acrylate, tri- or polyfunctional (particularly preferably tetra- or polyfunctional) urethane(meth)acrylate is preferably contained. That is, a compound having three or more (meth)acrylic groups (particularly preferably four or more (meth)acrylic groups) in the molecule is preferably contained. In this case, the position or the number of urethane bonds, or whether the (meth)acrylic group is located at the molecular terminal is not particularly limited. A compound having 6 or more (meth)acrylic groups in the molecule is particularly preferred, and a compound having 9 or more (meth)acrylic groups is further preferred. The upper limit of the number of the (meth)acrylic groups in the molecule is not particularly limited, but is particularly preferably 15.

When the number of the (meth)acrylic groups in the molecule of urethane(meth)acrylate is too small, the crosslinking density or curability of the resultant antireflection film having an unevenness structure may be reduced, and the storage elastic modulus at 25° C. and/or 180° C. may become extremely low, or the antireflection film having an unevenness structure may become extremely soft. Thus, the surface scratch resistance may be deteriorated, so that a sufficient mechanical strength may not be obtained. Meanwhile, when the number of the (meth)acrylic groups in the molecule of urethane(meth)acrylate is too large, the crosslinking density or curability of the resultant antireflection film having an unevenness structure is increased while the storage elastic modulus at 25° C. and/or 180° C. may become extremely high, or the film quality of the antireflection film having an unevenness structure may become extremely brittle. Thus, the surface scratch resistance may be deteriorated so that a sufficient mechanical strength may not be obtained.

When the (meth)acrylate compound contains polyethylene glycol di(meth)acrylate and urethane(meth)acrylate, the curability and flexibility may be improved due to a synergy effect, thereby sufficiently achieving a mechanical strength such as a surface scratch resistance or an antifouling property. Also, when the fluorine-based surfactant (particularly, a fluorine-based surfactant having an alkylene oxide repeating structure and a fluoroalkyl group) is further contained, due to a synergy effect thereof, especially, the curability and flexibility may be improved, thereby highly properly achieving the mechanical strength such as a surface scratch resistance or the antifouling property.

Tri- or polyfunctional (preferably tetra- or polyfunctional) urethane(meth)acrylate is preferably included in an amount of 10% by mass or more in the (meth)acrylate compound, more preferably of 20% by mass or more, and particularly preferably of 30% by mass or more, and also preferably of less than 47% by mass. Within the range described above, the curability and the flexibility are excellent, and the scratch resistance is improved.

The structure of the tri- or polyfunctional urethane(meth)acrylate is not particularly limited, but is preferably obtained by reacting an isocyanate group of a polyfunctional isocyanate compound (a), with a hydroxyl group of a compound (b) which contains one hydroxyl group and two or more (meth)acrylic groups in the molecule. The structure of the tetra- or polyfunctional urethane(meth)acrylate is also the same as described above.

The number of isocyanate groups contained in the polyfunctional isocyanate compound (a) preferably ranges from 2 to 6, and particularly from 2 to 3. When the number falls short of the range, the flexibility may be insufficient, and when the number exceeds the range, the hardness may become extremely low, or the viscosity of the curable composition may be extremely increased.

The polyfunctional isocyanate compound (a) is not particularly limited, but a compound having two or more isocyanate groups in the molecule may be exemplified. As for the compound having two isocyanate groups in the molecule, for example, 1,5-naphthylenediisocyanate, 4,4′-diphenylmethane diisocyanate, hydrogenated diphenyl methane diisocyanate, 1,3-phenylene diisocyanate, 1,4-phenylene diisocyanate, tolylene diisocyanate, butane-1,4-diisocyanate, hexamethylene diisocyanate, 2,2,4-trimethylhexamethylene diisocyanate, 2,4,4-trimethylhexamethylenediisocyanate, cyclohexane-1,4-diisocyanate, xylylene diisocyanate, isophorone diisocyanate, lysine diisocyanate, dicyclohexylmethane-4,4′-diisocyanate, 1,3-bis(isocyanatemethyl)cyclohexane, methyl cyclohexane diisocyanate, and m-tetramethylxylylene diisocyanate may be exemplified.

As for the compound having three isocyanate groups in the molecule, for example, “trimethylolpropane addition adduct products, biuret products, and isocyanurate products in which a 6-membered ring is formed by trimerization, which are obtained by modifying, for example, isophorone diisocyanate, tolylene diisocyanate, hexamethylene diisocyanate, or xylylenediisocyanate” may be exemplified. The bifunctional isocyanate as a starting material for the isocyanurate product is not particularly limited, but in the present invention, an isocyanurate product of isophorone diisocyanate, tolylene diisocyanate, or hexamethylene diisocyanate (HDI) is more preferred, and an isocyanurate product in which hexamethylene diisocyanates (HDI) are trimerized is particularly preferred because it has a distance between functional groups, and has a structure capable of providing flexibility.

The compound (b) having one hydroxyl group and two or more (meth)acrylic groups in the molecule is not particularly limited, but a compound obtained by reacting (p-1) (meth)acrylic acids with hydroxyl groups of a compound (b-1) having three or more hydroxyl groups (the number is p) in the molecule; or a compound obtained by ring-opening reaction of glycidyl (meth)acrylate and (meth)acrylic acid may be exemplified.

Here, the “compound (b) having one hydroxyl group and two or more (meth)acrylic groups in the molecule” also includes the case where a compound having two or more hydroxyl groups in the molecule is migrated and the case where a compound having one (meth)acrylic group is migrated when the compound is produced by partially reacting two or more kinds of compounds.

Among the compounds (b), the “compound (b-1) having 3 or more hydroxyl groups in the molecule” in the “compound in which (p-1) (meth)acrylic acids are reacted with the compound (b-1) having p (p is an integer of 3 or more) hydroxyl groups in the molecule” is not particularly limited, but for example, glycerin, trimethylolethane, trimethylolpropane, pentaerythritol, tetramethylolethane, diglycerin, ditrimethylolethane, ditrimethylolpropane, dipentaerythritol and ditetramethylolethane; an ethylene oxide-modified compound thereof; a propylene oxide-modified compound thereof; compounds of isocyanuric acid modified by ethylene oxide, modified by propylene oxide or modified by E-caprolactone; and oligo ester may be exemplified.

The number of the hydroxyl groups in the compound (b-1) is particularly preferably 4 or more in view of increasing the number of the functional groups in the resulting urethane (meth)acrylate. That is, as for the compound (b-1), specifically, for example, pentaerythritol, tetramethylolethane, diglycerin, ditrimethylolethane, ditrimethylolpropane, dipentaerythritol, and ditetramethylolethane are particularly preferred.

In a case of diglycerin as an example, by reacting three hydroxyl groups among four hydroxyl groups of diglycerin with (meth)acrylic acid, the compound (b) having one hydroxyl group and two or more (in this case, three) (meth)acrylic groups in the molecule is synthesized. Further, for example, in a case where the polyfunctional isocyanate compound (a) is isophoronediisocyanate, the above-mentioned two compounds (b) having one hydroxyl group and two or more (meth)acrylic groups are reacted with two isocyanate groups of isophoronediisocyanate so that “tetra- or higher-functional urethane(meth)acrylate” is synthesized. Here, when a compound (b) having one hydroxyl group and three (meth)acrylic groups in the molecule is reacted with isophoronediisocyanate, a “tetra- or higher-functional urethane(meth)acrylate” having six (meth)acrylic groups in the molecule is consequently synthesized.

a-1-3. Polyol(Meth)Acrylate

The (meth)acrylate compound for forming the antireflection film having an unevenness structure of the present invention may contain polyol(meth)acrylate. The “polyol(meth)acrylate” in the present invention means a material obtained by dehydration condensation reaction of an alcohol and a (meth)acrylic acid, other than polyethylene glycol di(meth)acrylate described above, which does not have a urethane bond and a siloxane bond.

As for the bifunctional polyol(meth)acrylate, for example, a linear alkanediol di(meth)acrylate such as 1,4-butanediol di(meth)acrylate, 1,6-hexanediol di(meth)acrylate, and 1,9-nonanediol di(meth)acrylate; an alkylene glycol di(meth)acrylate such as dipropylene glycol di(meth)acrylate, tripropylene glycol di(meth)acrylate, tetrapropylene glycol di(meth)acrylate, polypropyleneglycol#400di(meth)acrylate, and polypropyleneglycol#700di(meth)acrylate; partial (meth)acrylate ester of tri- or higher-valent alcohol such as pentaerythritol di(meth)acrylate, pentaerythritoldi(meth)acrylate monostearate, and pentaerythritoldi(meth)acrylate mono benzoate; bisphenol-based di(meth)acrylate such as bisphenol A di(meth)acrylate, EO-mofidied bisphenol A di(meth)acrylate, PO-mofidied bisphenol A di(meth)acrylate, hydrogenated bisphenol A di(meth)acrylate, EO-mofidied hydrogenated bisphenol A di(meth)acrylate, PO-mofidied hydrogenated bisphenol A di(meth)acrylate, bisphenol F di(meth)acrylate, EO-mofidied bisphenol F di(meth)acrylate, PO-mofidied bisphenol F di(meth)acrylate, and EO-mofidied tetrabromobisphenol A di(meth)acrylate; neopentyl glycol di(meth)acrylate, and neopentyl glycol PO-modified di(meth)acrylate; hydroxypivalic acid neopentyl glycolester di(meth)acrylate, and caprolactone added-di(meth)acrylate of hydroxypivalate neopentyl glycol ester; 1,6-hexanediol bis(2-hydroxy-3-acryloyloxypropyl)ether; and di(meth)acrylate such as tricyclodecanedimethyloldi(meth)acrylate, and isocyanuric acid EO-modified di(meth)acrylate may be exemplified.

Above all, bifunctional polyol(meth)acrylate is preferred in order to impart flexibility so that the storage elastic modulus at 25° C. and/or 180° C. is adjusted.

As for the trifunctional polyol(meth)acrylate, for example, glycerin PO-modified tri(meth)acrylate, trimethylolpropane tri(meth)acrylate, trimethylolpropane EO-modified tri(meth)acrylate, trimethylolpropane PO-modified tri(meth)acrylate, isocyanuric acid EO-modified tri(meth)acrylate, isocyanuric acid EO-modified ε-caprolactone-modified tri(meth)acrylate, 1,3,5-triacryloylhexahydro-s-triazine, pentaerythritol tri(meth)acrylate, and dipentaerythritol tri(meth)acrylatetripropionate may be exemplified.

As for the tetra- or polyfunctional polyol(meth)acrylate, for example, pentaerythritoltetra(meth)acrylate, dipentaerythritol penta(meth)acrylate monopropionate, dipentaerythritol hexa(meth)acrylate, tetramethylolethanetetra(meth)acrylate, and oligoester tetra(meth)acrylate may be exemplified. These may be used singly or as a mixture of two or more kinds thereof.

When the tri- or polyfunctional or the tetra- or polyfunctional polyol(meth)acrylate is blended, the film quality (antireflection film having an unevenness structure) may become too hard, or the storage elastic modulus at 25° C. and/or 180° C. may be increased, and thus, the scratch resistance may become worse.

The curable composition in the present invention may be mixed with a monofunctional or bifunctional polymerizable monomer as a viscosity modifier to be used. Among the following two blend types to be described below, any one may be preferably employed.

In a blend type according to a first aspect, the viscosity of the curable composition is low (20 mPa·s or less), the pattern formability is particularly emphasized, and a monofunctional polymerizable monomer and a bifunctional polymerizable monomer are mainly used. The total of the monofunctional polymerizable monomer and the bifunctional polymerizable monomer based on the total amount of the polymerizable monomers is preferably 80% by mass or more. The monofunctional polymerizable monomer is preferably used in an amount of 10% to 100% by mass, more preferably of 10% to 80% by mass, and further preferably of 10% to 30% by mass. Also, in order to emphasize the elastic modulus, the bifunctional polymerizable monomer is preferably 50% by mass or more, and more preferably ranges from 70% to 90% by mass.

In a blend type according to a second aspect, the viscosity of the curable composition ranges from about 6 mPa·s to 300 mPa·s, the pattern formability and thick film suitability are emphasized, and a bifunctional to hexafunctional polymerizable monomer is mainly used. The total of the bifunctional to hexafunctional polymerizable monomers based on the total amount of the polymerizable monomers is preferably 90% by mass or less. Above all, the total of the bifunctional to tetrafunctional polymerizable monomers preferably ranges from 30% to 100% by mass, and more preferably from 60% to 90% by mass. Also, in an aspect where the bifunctional to tetrafunctional polymerizable monomers are included in an amount of 60% to 90% by mass, it is particularly preferred that a monofunctional or penta- to hexafunctional polymerizable monomer is further used in combination. According to this aspect, the viscosity or hardness of the curable composition may be easily adjusted, and the pattern formability, thick film suitability, and substrate adhesion may be easily imparted.

Hereinafter, preferred examples of the monofunctional or bifunctional polymerizable monomer for viscosity adjustment used in the present invention will be described, but it is needless to say that the present invention is not limited thereto. As for the polymerizable monomer for viscosity adjustment, monomers having a polymerizable group may be widely employed. The kind of the polymerizable group is not particularly limited, but, a (meth)acrylate group, a vinyl group or an epoxy group is preferred, a (meth)acrylate group is more preferred, and an acrylate group is further preferred. In a polymerizable monomer having two kinds of polymerizable groups, the respective polymerizable groups may be same or different.

The molecular weight of the polymerizable monomer for viscosity adjustment is preferably 1000 or less, and more preferably 600 or less in order to constitute a low viscosity composition. Within this range, the viscosity of the curable composition in the present invention may be a lower level. The lower limit of the molecular weight of the polymerizable monomer for viscosity adjustment, which is used in the present invention, is not particularly determined, but is generally 100 or more.

As for a monofunctional polymerizable monomer for viscosity adjustment, a polymerizable unsaturated monomer (monofunctional polymerizable unsaturated monomer) having one ethylenically unsaturated bond-containing group may be exemplified. The monofunctional polymerizable unsaturated monomer is suitable for lowering the viscosity of the composition. From the viewpoint of a low viscosity, a vinyl compound, and a (meth)acrylate compound are preferred. Particularly, acryloyl morpholine, phenoxyethyl acrylate, N-vinyl pyrrolidone, benzyl acrylate, 2-hydroxyethyl (meth) acrylate, trimethoxysilyl propyl acrylate, and ethyl oxetanylmethyl acrylate are more preferred. In view of transparency, benzyl acrylate is preferred. Also, as for the polymerizable monomer used in the present invention, a styrene derivative may also be employed. As for the styrene derivative, for example, p-methoxy styrene, p-methoxy-P-methyl styrene, and p-hydroxystyrene may be exemplified.

As for the bifunctional polymerizable monomer for viscosity adjustment, a polymerizable unsaturated monomer having two ethylenically unsaturated bond-containing groups may be exemplified. The bifunctional polymerizable unsaturated monomer is suitable for lowering the viscosity of the composition. In the present invention, a (meth)acrylate-based compound is preferred which is excellent in reactivity and is free from, for example, a residual catalyst.

Particularly, for example, neopentyl glycol di(meth)acrylate, 1,9-nonane diol di(meth)acrylate, tripropylene glycol di(meth)acrylate, tetraethyleneglycol di(meth)acrylate, hydroxypivalic acid neopentylglycol di(meth)acrylate, polyethylene glycol di(meth)acrylate, dicyclopentenyl (meth)acrylate, dicyclopentenyloxyethyl(meth)acrylate, and dicyclopentanyl di(meth)acrylate may be properly used in the present invention.

Further, for the purpose of improving the mold releasing property or coatability, a fluorine-based monomer such as trifluoroethyl (meth) acrylate, pentafluoroethyl (meth) acrylate, (perfluorobutyl) ethyl (meth) acrylate, perfluorobutyl-hydroxypropyl (meth) acrylate, (perfluorohexyl) ethyl (meth) acrylate, octafluoropentyl (meth) acrylate, perfluorooctyl ethyl (meth) acrylate and tetrafluoro propyl (meth)acrylate may also be used in combination.

As for the polymerizable monomer for viscosity adjustment used in the present invention, a compound having an epoxy group, a compound having an oxirane ring, or a compound having an oxetane ring may be employed. When the compound having an epoxy group or an oxirane ring is used in combination with a (meth)acrylate compound, the elastic recovery rate tends to be significantly improved.

As for the compound having an oxirane ring, for example, polyglycidyl esters of polybasic acids, polyglycidyl ethers of polyhydric alcohols, polyglycidyl ethers of polyoxyalkylene glycols, polyglycidyl ethers of aromatic polyols, hydrogenated compounds of polyglycidyl ethers of aromatic polyols, urethane polyepoxy compounds and epoxidized polybutadienes may be exemplified. These compounds may be used singly or as a mixture of two or more kinds thereof.

As for the epoxy compound which may be preferably used, for example, alicyclic epoxy compounds, 3,4-epoxy cyclohexylmethyl-3,4-epoxy cyclohexane carboxylate, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, and polypropylene glycol diglycidyl ethers; polyglycidyl ethers of polyether polyols obtained by the addition of one or more alkylene oxides to aliphatic polyhydric alcohols such as ethylene glycol, propylene glycol, and glycerol; diglycidyl esters of aliphatic long-chain dibasic acids; monoglycidyl ethers of aliphatic higher alcohols; monoglycidyl ethers of phenol, cresol, butylphenol, or polyether alcohol obtained by adding alkylene oxide thereto; and glycidyl esters of higher fatty acids may be exemplified.

Among these components, an alicyclic epoxy compound, 3,4-epoxy cyclohexylmethyl-3,4-epoxy cyclohexane carboxylate, bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, neopentylglycol diglycidyl ether, polyethylene glycol diglycidyl ether, and polypropyleneglycol diglycidyl ether are preferred.

As for the oxetane ring-containing compound which may be preferably used, for example, an alicyclic oxetane compound, an oxetane compound having a siloxane moiety, and an oxetane compound having a dihydroxybenzene moiety may be exemplified. Specifically, for example, bis(3-ethyl-3-oxetanylmethyl)ether, xylylene bisoxetane, and 2-ethylhexyl oxetane are preferred. For example, those described in Japanese Patent Laid-Open Publication Nos. 2002-256057, 2004-250434, 2004-43609, 2006-206762, 2004-43609, and 2004-250434 may be preferably employed.

As for a commercially available product which may be properly used as a glycidyl group-containing compound, for example, UVR-6110, UVR-6216 (manufactured by Union Carbide Corporation), GLYCIDOL, AOEX24, CYCLOMER A200 (manufactured by Daicel Chemical Industries, Ltd.), Epicoat 828, Epicoat 812, Epicoat 1031, Epicoat 872, Epicoat CT508 (manufactured by Yuka Shell Co., Ltd.), and KRM-2400, KRM-2410, KRM-2408, KRM-2490, KRM-2720, KRM-2750 (manufactured by Asahi Denka Kogyo Co., Ltd.) may be exemplified. As for a commercially available product which may be properly used as an oxetane ring-containing compound, for example, OXT-101, OXT-212, OXT-121, and OXT-221 (manufactured by TOAGOSEI CO., LTD.) may be exemplified. These may be used singly or in combination of two or more kinds thereof.

A production method of the compound having the oxirane ring is not specifically limited. For example, the compound may be synthesized with reference to publications such as, for example, “Lecture of Experimental Chemistry 20, 4th Ed., Organic Synthesis II” p. 213, ff. (Maruzen K K Shuppan, 1992); “The chemistry of heterocyclic compounds—Small Ring Heterocycles, Part 3, Oxiranes” (edited by Alfred Hasfner, John & Wiley and Sons, An Interscience Publication, New York, 1985); Yoshimura, Adhesive, Vol. 29, No. 12, 32, 1985; Yoshimura, Adhesive, Vol. 30, No. 5, 42, 1986; Yoshimura, Adhesive, Vol. 30, No. 7, 42, 1986; and Japanese Patent Laid-Open Publication No. H11-100378, Japanese Patent Nos. 2906245, and 2926262.

As for the polymerizable monomer for viscosity adjustment used in the present invention, a vinyl ether compound may be used. As for the vinyl ether compound, conventionally known compounds may be properly selected, and for example, those described in paragraph 0057 of Japanese Patent Laid-Open Publication No. 2009-73078 may be preferably employed.

These vinyl ether compounds may be synthesized according to, for example, the method described in Stephen. C. Lapin, Polymers Paint Colour Journal. 179 (4237), 321 (1988), that is, through a reaction of a polyalcohol or a polyphenol with acetylene, or through a reaction of a polyalcohol or a polyphenol with a halogenoalkyl vinyl ether. These may be used singly or in combination of two or more kinds thereof.

In the curable composition of the present invention, a silsesquioxane compound having a reactive group described in Japanese Patent Laid-Open Publication No. 2009-73078 may be used in view of a low viscosity, a pattern accuracy improvement, and a high hardness. Also, as for a material excellent in the mold releasing property and the cured film strength, a compound having an ester group having an unsaturated double bond and a (meth)acrylate group within the same molecule as described in International Publication Pamphlet No. WO2009/110496 may also be used.

In the curable composition in the present invention, the water content at the time of adjustment is preferably 5.0% by mass or less, more preferably 2.5% by mass, and further more preferably 1.0% by mass or less. When the water content at the time of adjustment is 5.0% by mass or less, the storage stability of the curable composition in the present invention may be more stabilized.

(b) Fine Particles

Fine particles useful for the curable composition of the present invention are added for the main purpose of improving an interface adhesion to an antifouling layer when the antifouling layer is formed by (A) an atmospheric pressure plasma treatment described below. Also, the fine particles which make the resultant cured composition transparent may be selected and used so as to adjust the refractive index of the cured film. The addition of the fine particles may suppress the curing shrinkage of the cured film, and thus is effective in suppressing the reduction of an aspect ratio caused by the curing shrinkage, and improving the deterioration of a substrate adhesion. Hereinafter, the fine particles used in the present invention will be described.

The fine particles are preferably inorganic fine particles, and for example, metals (e.g., Ni, Cu, Cr, Fe, Au, Ag), metal oxides (e.g., SiO₂, Al₂O₃, ZrO₂, ITO, SnO₂, ZnO, TiO₂, CaO, CdO, CeO₂, PbO, In₂O₃, La₂O₃ and complex oxides thereof), and metal nitrides (e.g., silicon nitride, boron nitride, titanium nitride, gallium nitride) may be exemplified.

Above all, inorganic metal oxide particles are preferred in view of the transparency of the cured coating film, the hardness and the curing shrinkage suppression, and particularly, SiO₂, Al₂O₃, ZrO₂, and TiO₂ are preferred, and SiO₂ is more preferred. These may be used singly or in combination of two or more kinds thereof. Such inorganic oxide fine particles may be used either in a powder form or a solvent-dispersed sol. In a case of the solvent-dispersed sol, an organic solvent is preferred as a dispersion medium in view of the compatibility with other components, and dispersibility. Above all, methanol, isopropanol, butanol, methyl ethyl ketone, methyl isobutyl ketone, ethyl acetate, butyl acetate, toluene, and xylene are preferred. Also, in order to improve the dispersibility of the particles, various surfactants, dispersing agents, and amines may be added.

The fine particle used in the curable composition of the present invention preferably has a hydrophilic surface. It is desirable that the surface of the fine particle is not subjected to surface treatment in view of improving the affinity to the mold, and particularly in view of imparting an adhesion force on an antifouling layer formed by atmospheric pressure plasma treatment. In a case of the surface treatment, a silane coupling agent, a zirconium coupling agent, an aluminum coupling agent, or a titanium coupling agent is preferably used. It is desirable that these coupling agents provide a hydrophilic group such as an amino group, a glycidyl group, an oxetanyl group or provide hydrophilicity after the reaction. Particularly, a cationic polymerizable functional group of a glycidyl group or an oxetanyl group is preferred. By introducing these cationic polymerizable functional groups, it is possible to achieve the improvement of the affinity of the fine particles to the mold, and the increase of the strength of the adhesion force to the antifouling layer.

If modification with a hydrophobic group is performed to impart dispersibility in the organic solvent, specifically, a coupling agent having, for example, an alkyl group or a mercapto group, which shows a higher hydrophobicity than an unmodified silanol group, is used, and the modification rate is preferably 30% or less, more preferably 20% or less, and further more preferably 10% or less.

The fine particles used in the present invention are preferably contained in the surface having an unevenness structure.

The shape of the fine particles used in the present invention is not particularly limited, but the fine particles may be spherical, hollow, porous, rod-shaped, plate-shaped, cube-shaped, rectangular parallelepiped, fibrous-shaped or amorphous, and preferably spherical or hollow.

The average particle size of the fine particles preferably ranges from 0.5 nm to 50 nm in view of the transparency of the resultant cured film, and more preferably from 1 nm to 20 nm. Also, in the present invention, the fine particles may not be spherical. In a case of shapes other than the spherical shape, the average particle size (diameter) refers to a value when the particle is converted into a sphere having the same volume. As for the particle size of the fine particles, an average of 100 particles observed by a light transparency electron microscope may be used. Also, the addition amount of the fine particles may preferably range from 0.5% to 50% by mass based on the composition of the present invention. The amount more preferably ranges from 1% to 40% by mass, and still more preferably from 5% to 30% by mass. When the addition amount of the fine particles is 0.5% by mass or more, the mechanical strength such as the scratch resistance, the abrasion resistance, and the dynamic characteristic tends to be improved, and when the addition amount is 50% by mass or less, the liquid viscosity of the curable composition may be lowered, so that the storage stability or the transparency tends to be improved.

(c) Polymerization Initiator

The curable composition in the present invention contains a polymerization initiator which generates radicals, acids or bases by the action of light and/or heat. This triggers a curing reaction. Above all, in view of a high degree of freedom in selecting a curable material, a short time required for the curing reaction, and a capability of reducing the size of a manufacturing apparatus, it is preferred to contain a photo-radical initiator which generates radicals by photo-irradiation.

As for the photo-radical polymerization initiator, acetophenones, benzoins, benzophenones, phosphine oxides, ketals, anthraquinones, thioxanthones, azo compounds, peroxides (e.g., Japanese Patent Laid-Open Publication No. 2001-139663), 2,3-dialkyldione compounds, disulfide compounds, fluoroamine compounds, aromatic sulfoniums, lophine dimers, onium salts, borate salts, active esters, active halogens, inorganic complexes, and coumarins may be exemplified.

The polymerization initiator may be used singly or as a mixture thereof.

Various examples are described in “The Latest UV Curing Techniques”, Technical Information Institute Co., Ltd. (1991), p. 159, and in “Ultraviolet Curing System”, Kiyomi Kato (Pub. Sougou Gijyutsu Center, 1989), pp. 65 to 148, which are useful in the present invention. Also, as specific examples of the compound of the photopolymerization initiator used in the present invention, those described in paragraph 0091 of Japanese Patent Laid-Open Publication No. 2008-105414 may be preferably employed.

As for a commercially available photo-radical polymerization initiator, KAYACURE manufactured by Nippon Kayaku Co., Ltd. (e.g., DETX-S, BP-100, BDMK, CTX, BMS, 2-EAQ, ABQ, CPTX, EPD, ITX, QTX, BTC, MCA), Irgacure manufactured by Ciba Specialty Chemicals Inc. (e.g., 651, 127, 184, 500, 819, 907, 369, 379, 1173, 1870, 2959, 4265, 4263), polymerization initiators manufactured by BASF (Lucirin TPO, TPO-1, LR8893, LR8970), polymerization initiators manufactured by UCB Co., Ltd. (Ubecryl P36) and combinations thereof may be mentioned as preferable examples.

Also, in the present invention, a photoacid generator, a photosensitizer or a thermal initiator may also be used. Specific examples of the polymerization initiator, and the sensitizer are described in paragraphs 0190 to 0219 of Japanese Patent Laid-Open Publication No. 2007-298974. As for the photopolymerization initiator, an initiator having an activity to the wavelength of the light source to be used so as to generate proper active species is blended and used in the present invention. In this manner, the sensitivity may be improved, and the exposure time may be shortened.

The polymerization initiator is contained in a range of 0.1% to 15% by mass, preferably of 0.2% to 12% by mass, and still more preferably of 0.3% to 10% by mass based on the total amount of the curable composition in the present invention. When two or more kinds of polymerization initiators are used, the total amount falls within the range described above. It is preferred that the ratio of the polymerization initiator is 0.1% by mass or more in view of improving the sensitivity (rapid curability), resolution, line edge roughness, and coating film strength. Meanwhile, it is preferred that the ratio of the polymerization initiator is 15% by mass or less in view of improving the light transmittance, colorability, and handleability.

(d) Releasing Agent

The curable composition in the present invention preferably contains a releasing agent. When the releasing agent is used, the surface state of the coating film of the curable composition may be improved to improve the pattern accuracy. The releasing agent used in the present invention is contained in a range of, for example, 0.01% to 10% by mass, preferably of 0.1% to 10% by mass, and further more preferably of 1% to 8% by mass. When two or more kinds of releasing agents are used, the total amount falls within the range described above. Meanwhile, the content described above is a content of the component excluding the solvent in the composition.

The releasing agent preferably includes at least one kind selected from a silicone-containing releasing agent, a fluorine-containing releasing agent, a silicone-containing and fluorine-containing releasing agent, and a linear aliphatic alkyl-based releasing agent, more preferably includes at least one kind selected from a silicone-containing releasing agent, a fluorine-containing releasing agent and a silicone-containing and fluorine-containing releasing agent, and still more preferably includes at least one kind selected from a silicone-containing releasing agent and a silicone-containing and fluorine-containing releasing agent.

By using such a surfactant, the coating uniformity may be largely improved, and in the coating using a die coater or a slit scanning coater, a good coatability may be obtained regardless of a transparent substrate film size.

The curable composition in the present invention preferably further contains a fluorine-based surfactant, and particularly preferably contains a fluorine-based surfactant having an alkylene oxide repeating structure and a fluoroalkyl group. By containing the fluorine-based surfactant, a scratch hardly occurs on the surface of the antireflection film having an unevenness structure (the surface scratch resistance is improved).

The “fluorine-based surfactant” means a compound having a fluorine atom and having a surface activity, and the chemical structure is not particularly limited as long as it contains a fluorine atom. Any compound, in which a fluorine atom-containing group is a hydrophobic group, to which a hydrophilic group is bonded to have a property as a surfactant, may be included in the present invention. However, it is desirable that the fluorine-based surfactant in the present invention has an alkylene oxide repeating structure and a fluoroalkyl group.

Such an “alkylene oxide” is particularly preferably ethylene oxide in view of improving the surface scratch resistance and the antifouling property.

The alkylene oxide repeating structure may have one kind of alkylene oxide chain or two or more kinds of alkylene oxide chains.

The repetition number of the alkylene oxide repeating structure preferably ranges from 4 to 20, more preferably from 4 to 16, and particularly preferably from 4 to 12.

The carbon number of the fluoroalkyl group is not particularly limited, but preferably ranges from 2 to 18, more preferably from 3 to 14, and particularly preferably from 4 to 8.

The fluoroalkyl group is particularly a perfluoroalkyl group. That is, as for the fluorine-based surfactant, a perfluoroalkyl ethylene oxide adduct is particularly preferred.

The carbon number of the perfluoroalkyl group is not particularly limited, but preferably ranges from 2 to 18, more preferably from 3 to 14, and particularly preferably from 4 to 8.

The specific structure of the fluorine-based surfactant is preferably a structure in which the alkylene oxide repeating structure and the fluoroalkyl group are serially connected, and a material having the structure represented by Formula (F) below, in which the alkylene oxide repeating structure and the fluoroalkyl group are serially connected, may be described as a particularly preferred example of the fluorine-based surfactant.

When the fluorine-based surfactant represented by Formula (1) below is contained in the curable composition, it is possible to obtain an antireflection film having an unevenness structure which is highly excellent in the mechanical strength such as a surface scratch resistance, and the antifouling property.

R¹(CF₂)ₚ—XCHR²—CH₂—O_{q}R³ (F)

In Formula (F), R¹ represents H or F, R² represents H or CH₃, R³ represents H or CH₃, X represents a divalent linking group, p is an integer of 2 to 18, and q is an integer of 4 to 20.

In Formula (F), it is preferable that R¹ is F, and R² is H in view of the surface scratch resistance and the antifouling property.

Also, p is preferably an integer of 3 to 14 in view of the surface scratch resistance and the antifouling property, is more preferably an integer of 4 to 10, and still more preferably an integer of 6 to 8.

q is preferably an integer of 4 to 16 in view of the surface scratch resistance and the antifouling property, and particularly preferably an integer of 5 to 10.

X represents a divalent linking group, more preferably a divalent linking group having 1 to 16 atoms including a hydrogen atom, and particularly preferably a divalent linking group having 1 to 10 atoms including a hydrogen atom. A divalent linking group having 1 to 6 atoms excluding a hydrogen atom is more preferred, and a divalent linking group having 1 to 4 atoms excluding a hydrogen atom is particularly preferred.

Specifically, further preferably, X represents, for example, “—Y—O—” (Y represents an alkylene group having 1 to 5 carbon atoms, preferably an ethylene group or a propylene group), “—O—” or “—COO—” in view of the surface scratch resistance and the antifouling property.

Meanwhile, in recent years, a perfluorooctanoic acid (PFOA) is limited in its use due to its high bioaccumulation potential, so that when the PFOA is used as a starting material (e.g., p=7, and X=“—COO—” in Formula (F) above), some difficulties may occur in view of the practical use.

The fluorine-based surfactant is particularly preferably a perfluoroalkyl ethylene oxide adduct in which R¹ in formula (F) is F, a carbon number of the perfluoroalkyl group ranges from 4 to 8, R² in formula (F) is H, and a repetition number of the ethylene oxide repeating structure ranges from 4 to 12.

The blending amount of the fluorine-based surfactant to be used generally ranges from 0.1 parts to 10 parts by mass, preferably from 0.3 parts to 5 parts by mass, and particularly preferably from 0.5 parts to 3 parts by mass based on 100 parts by mass of the (meth)acrylate compound.

When the amount falls short of the range above, an abrasion resistance improving effect on the surface of the antireflection film having an unevenness structure may not be sufficiently obtained, while when the amount largely exceeds the range, the compatibility with the (meth)acrylate compound becomes worse, so that the curable composition itself for forming the antireflection film having an unevenness structure becomes turbid (in the state of a liquid), whereby the transparency of the resulting antireflection film having an unevenness structure is lowered or the fluorine-based surfactant is liberated on the surface of the antireflection film having an unevenness structure to contaminate the surroundings in some cases.

As for the silicon-containing compound, a compound having a HLB ranging from 6 to 11 is preferably used. Here, HLB numerically indicates the hydrophilic-hydrophilic balance of oil, and is an abbreviation of a value of hydrophile and liophile balance. The range is determined in view of the compatibility. Specific descriptions are noted in manufacturer catalogs.

The preferred use amount is varied according to the value of HLB. When the HLB value ranges from 6 to 8.5, the compound may be included in the curable composition, in a range of 0.5% to 3.0% by mass, and preferably of 0.7% to 2.0% by mass, and when the HLB value is higher than 8.5 and 11 or less, the compound may be included in a range of 2.0% to 5.0% by mass, and preferably of 2.5% to 4.0% by mass.

As for the silicon-containing compound, an unmodified or modified compound is used. Preferably, a modified silicon oil in which a side chain and/or terminal of polysiloxane is modified is preferred. The modified silicone oils are classified into reactive silicone oils and non-reactive silicone oils. Examples of the reactive silicone oil may include an amino-modified silicone oil, an epoxy-modified silicone oil, a carboxyl-modified silicone oil, a carbinol-modified silicone oil, a (meth)acryl-modified silicone oil, a mercapto-modified silicone oil, a phenol-modified silicone oil, a one-terminal reactive silicone oil, and a heterogeneous functional group-modified silicone oil. Examples of the non-reactive silicone oil may include a polyether-modified silicone oil, a methylstyryl-modified silicone oil, an alkyl-modified silicone oil, a higher fatty ester-modified silicone oil, a hydrophilic specially-modified silicone oil, a higher alkoxy-modified silicone oil, a higher fatty acid-modified silicone oil, and a fluorine-modified silicone oil. In view of the compatibility with a polymerizable monomer, a (meth)acryl-modified silicone oil or a polyether-modified silicone oil is particularly preferred.

Two or more of modifications described above may be carried out for one polysiloxane molecule. Particularly, when a reactive silicone oil, which is reactive with other coating film components to be used in the curable composition, is used, a problem such as adhesiveness inhibition, contamination, and deterioration of the cured film hardly occur because the silicone oil is fixed into the cured film of the curable composition of the present invention by a chemical bond. In particular, it is more effective in enhancing adhesiveness to a deposited layer during a deposition process. Also, in a case of a silicone modified with a functional group having a photo-curability such as a (meth)acryloyl-modified silicon, and a vinyl-modified silicone, the silicone is cross-linked with the curable composition in the present invention, thereby providing excellent properties after the curing.

As for the silicone-based releasing agent, tradename SI-10 series (manufactured by Takemoto Oil & Fat Co., Ltd.), Megafac pane Todd 31 (manufactured by DIC Corp.), and KP-341 (manufactured by Shin-Etsu Chemical Co., Ltd.) may be exemplified.

As for the polyether-modified silicone oil, SF8427, SH3749, FZ-77, L-7002, SH8400, SH3773M, FZ-2208 (manufactured by Dow Corning Toray Co., Ltd.), KF-352 Å, KF-353, KF-615A, and KF-6012 (manufactured by Shin-Etsu Silicon Co., Ltd.) may be exemplified. As for the (meth)acryl-modified silicone-based compound, X-22-174DX, X-22-2426, X-22-164B, X22-164C, X-22-1821 (manufactured by Shin-Etsu Chemical Co., Ltd.), FM-0725, FM-7725, FM6621, FM-1121, SILAPLANE FM0275, SILAPLANE FM0721 (manufactured by CHISSO Corporation), DMS-U22, RMS-033, RMS-083, UMS-182, DMS-H21, DMS-H31, HMS-301, FMS121, FMS123, FMS131, FMS141, and FMS221 (manufactured by Gelest) may be exemplified.

In view of the antifouling property, the water contact angle to the antireflection film of the present invention is preferably 100° or more, more preferably 110° or more, and still more preferably 120° or more.

In order to impart an antifouling property to the antireflection film, an antireflection layer preferably contains a fluorine-containing compound or a silicone compound in an amount of 1% by mass or less based on the total amount of the antireflection layer.

The fluorine-containing compound or the silicone compound preferably contains a polymerizable group in the molecule.

The fluorine compound preferably contains a polyether compound in the molecule.

The silicon compound preferably contains a polydimethylsiloxane unit having a molecular weight of 1000 or more.

In particular, in order to impart an antifouling property, it is preferable that an antifouling agent used in a hard coat layer described in [0012] to [0101] of Japanese Patent Laid-Open Publication No. 2012-88699 is properly used. Meanwhile, when the antifouling agent is added in the antireflection film having an unevenness structure in the present invention, the addition amount in the composition may be difference as described below.

[Contact Angle of Antireflection Layer Having Unevenness Structure]

The moth-eye structure has a very small unevenness. Thus, when the fluorine-containing compound or polysiloxane compound is uniformly present on the surface, a water repellent phenomenon which is a so-called lotus effect may be caused, so that the water contact angle to the antireflection layer becomes 100° or more. Then, the antifouling property becomes much better as compared to a case where the compound is present on a smooth surface.

Particularly preferably, the antireflection film of the present invention contains a fluorine-containing compound or a silicone compound, in which the water contact angle of the antireflection film is 110° or more, and the oleic acid contact angle to the antireflection film is 75° or more. The oleic acid contact angle is more preferably 80° or more, and still more preferably 85° or more. It is desirable that the oleic acid contact angle is 75° or more, because the adhesion of sebum or oil, particularly fingerprints of a human may be significantly suppressed.

The present invention also relates to a kit including an antireflection film and a cleaning cloth. In a cleaning method for removing dirt attached on the antireflection film having a moth-eye structure of the present invention, a specific cleaning cloth is preferably used. As for the cleaning cloth, a cloth having a smaller void or hole than a period of the moth-eye structure is preferred. Specifically, a cloth having a void or hole in a range of 50 nm to 380 nm (smaller than the visible light wavelength) is preferred, a cloth having a void or hole in a range of 50 nm to 300 nm is more preferred, and a cloth having a void or hole in a range of 50 nm to 200 nm is the most preferred. in a method of manufacturing such a cleaning cloth, as for the mixed fabric yarn constituted by two or more kinds of polyester filaments described in Japanese Patent Laid-Open Publication No. 2012-207322, it is preferable to use the nanofiber mixed fabric yarn whose elastic modulus at the time of 20% elongation is 70% or more and whose monofilament diameter ranges from 50 nm to 900 nm, in which at least one kind is polypropylene terephthalate or polybutylene terephthalate.

Furthermore, the water contact angle to the cleaning cloth is preferably less than 90°, more preferably less than 50°, and still more preferably less than 30°. The cloth employing the nanofiber mixed fabric yarn described in Japanese Patent Laid-Open Publication No. 2012-207322, as it is, is unsuitable because a water contact angle is 90° or more. Thus, the cloth needs to be subjected to a hydrophilic treatment such as a corona treatment or a saponification treatment.

A saponification treatment is a treatment which performs the acid washing for neutralization after a nanofiber mixed fabric yarn is immersed for a predetermined time in a warmed alkali aqueous solution, and water-washed. Any processing conditions may be employed as long as the hydrophilization of the nanofiber mixed fabric yarn is carried out. Thus, the concentration of a treating agent, the temperature of treating-agent liquid, and a processing time may be properly determined, but due to necessity of securing productivity, the processing conditions are determined so that the treatment is performed generally within 3 min. As general conditions, the alkali condition ranges from 3% by mass to 25% by mass, the processing temperature ranges from 30° C. to 70° C., and the processing time ranges from 15 sec to 5 min. The alkali species used suitably for the alkali treatment is sodium hydroxide or potassium hydroxide, the acid used suitably for acid washing is sulfuric acid, and the water used suitably for water-washing is ion exchange water or pure water.

(f) Antioxidant

The curable composition in the present invention may contain a conventionally known antioxidant. By containing the antioxidant, the transparency may be improved. Also, when the antioxidant is added and heat-curing is further performed after the light or electron beam curing in the present invention, a fine pattern highly excellent in the strength may be obtained. Here, as for the heat-curing conditions, the temperature preferably ranges from 150° C. to 280° C., and more preferably 200° C. to 250° C., and the heating time preferably ranges from 5 min to 60 min and still more preferably from 15 min to 45 min

The antioxidant used in the present invention is included preferably in a range of 0.1% to 10% by mass based on the total amount of the composition excluding a solvent, more preferably of 0.3% to 5% by mass, and most preferably of 1.0% to 5% by mass. When two or more kinds of antioxidants are used, the total amount thereof falls within the range.

The antioxidant is for preventing discoloration caused by heat or photo-irradiation and for preventing oxidation caused by various oxidizing gases such as ozone, active oxygen, NOx, SOx (X is an integer). Particularly, the present invention has an advantage in that by addition of the antioxidant, a coloring of the cured film may be suppressed, or a film thickness may be suppressed from being reduced through decomposition. As for the antioxidant, hydrazides, hindered amine-based antioxidants, nitrogen-containing heterocyclic mercapto compounds, thioether-based antioxidants, hindered phenol-based antioxidants, ascorbic acids, zinc sulfate, thiocyanates, thiourea derivatives, saccharides, nitrites, sulfites, thiosulfates, and hydroxylamine derivatives may be exemplified. Above all, particularly, hindered phenol-based antioxidants, and thioether-based antioxidants are preferred in view of suppressing the coloring of the cured film and the film thickness reduction.

The transmittance in the present invention may be evaluated in the following manner. The curable composition of the present invention is spin-coated on a glass substrate, exposed without mold crimping, and heated in an oven of 230° C. for 40 min. Then the transmittance of the cured film at a wavelength of 400 nm to 410 nm is measured and an arithmetic average is obtained. In addition, a film thickness is also measured, and a transmittance per 1 μm is calculated.

The transmittance is preferably 90% or more, more preferably 97% or more, still more preferably 98% or more, and particularly preferably 99% or more.

(g) Other components

In addition to the above mentioned components, the curable composition in the present invention may contain, if necessary, for example, a polymerization inhibitor, a UV absorber, a light stabilizer, an antiaging agent, a plasticizer, a colorant, elastomer particles, a refractive index modifier, inorganic oxide nanoparticles, light-scattering particles, a thermoplastic resin, a photoacid generator, a photobase generator, a basic compound, a flow control agent, a defoamer, a dispersing agent, and an adhesion improving agent. As for these, those described in, for example, Japanese Patent Laid-Open Publication No. 2009-73078 may be cited.

In the present invention, in the layer thickness, the ratio of a layer at the mold side /a layer at the transparent substrate film side preferably ranges from 1/300 to 1/1, more preferably from 1/100 to 1/1, still more preferably from 1/50 to 1/2, and particularly preferably from 1/20 to 1/3. When the ratio falls within this range, a coated surface state is excellent, and the releasing property may be improved. Also, effects such as a hardness increase and a curing shrinkage reduction according to addition of fine particles may be obtained.

The total thickness of the layer made of the curable composition may be optionally set according to a required pattern, and preferably ranges from 100 nm to 200 μm, more preferably from 400 nm to 100 μm, still more preferably from 900 nm to 30 μm, and particularly preferably from 3 μm to 10 μm.

The thickness of the layer made of the curable composition with respect to the maximum value of an unevenness difference of the mold pattern in the vertical direction of a transparent substrate film surface preferably ranges from 100% to 10000%, more preferably from 200% to 5000%, and still more preferably from 300% to 1000%. Within this range, the transfer accuracy of a pattern is excellent, thereby achieving both the releasing property and the adhesion.

The film thickness in the present invention refers to a value calculated by L/S when on the assumption that no unevenness is present on a main plane of a transparent substrate film or a mold, an area is S, and a coating amount of the curable composition coated on the region of the area S is L.

As for a manufacturing method of the antireflection film of the present invention, the following method is also preferred. That is, the curable composition may be applied onto a transparent substrate film so that a layer made of the curable composition may be applied to form a uniform thickness film through a generally well-known coating method, such as, for example, a dip coating method, an air knife coating method, a curtain coating method, a wire bar coating method, a gravure coating method, a die coating method, a spin coating method, and a slit scanning method. Here, the “transparent substrate film” is not particularly limited, but a film of polyethyleneterephthalate (hereinafter, abbreviated as “PET”) or triacetyl cellulose is appropriate. Then, a mold having the surface structure described above is bonded thereto. After bonding, polymerization is performed on the film surface by UV irradiation or electron beam irradiation and/or heat. Then, the polymerized curable composition is released from the mold to provide an antireflection film having a moth-eye structure of the present invention.

The following method is also preferred. That is, on the mold having the surface structure described above, a curable composition is directly applied. When the antireflection film having a moth-eye structure is placed in a film state, a layer made of the curable composition may be applied to form a uniform thickness film through for example, a die coating method, an air knife coating method, a curtain coating method, a wire bar coating method, a gravure coating method, a die coating method, a spin coating method, and a slit scanning method among generally well-known coating methods. Then, the polymerized curable composition is released from the mold to provide an antireflection film having a moth-eye structure of the present invention.

The particularly preferred manufacturing method of the antireflection film having a moth-eye structure is as follows. The manufacturing method of the antireflection film having a moth-eye structure includes: supplying a curable composition to a mold which has convex portions with an average height of 100 nm to 1000 nm or concave portions with an average depth of 100 nm to 1000 nm on the surface thereof, in which the concave portions or convex portions are present at an average cycle of 50 nm to 400 nm in at least one direction; press-bonding a transparent substrate film thereto; curing the curable composition; and releasing the cured product from the mold.

Also, in the manufacturing method of the antireflection film having a moth-eye structure, a curable composition containing a (meth)acrylate compound is supplied to a mold which has convex portions with an average height of 100 nm to 1000 nm or concave portions with an average depth of 100 nm to 1000 nm on the surface thereof, in which the concave portions or convex portions are present at an average cycle of 50 nm to 400 nm in at least one direction, and the curable composition is cured through light irradiation, electron beam irradiation and/or heating and then is released from the mold. Here, the (meth)acrylate compound contains polyethylene glycol di(meth) acrylate in an amount of 53% by mass or more based on the total amount of the (meth)acrylate compound.

Also, in a more preferred manufacturing method of the antireflection film having a moth-eye structure, the curable composition further contains a fluorine-based surfactant, and in a particularly preferred manufacturing method of the antireflection film having a moth-eye structure, the curable composition further contains a “fluorine-based surfactant having an alkylene oxide repeating structure and a fluoroalkyl group.”

The mold is not particularly limited, but, as an example, a mold in which the shape descried above is formed on the surface of the aluminum or aluminum alloys by repeating “anodic oxidation” and “etching of the anodized film obtained therefrom” is preferably exemplified. For example, the mold may be preferably manufactured by the method described in International Publication Pamphlet No. 2007/040159 or Japanese Patent Laid-Open Publication No. 2009-288337.

In the manufacturing method of the antireflection film having a moth-eye structure of the present invention, an appropriate amount of a curable composition is supplied or applied to the mold, and a transparent substrate film is bonded thereto from an oblique direction with a roller portion side as a fulcrum. A bonded body in which the mold, the curable composition, and the transparent substrate film are integrated is moved to a roller, and subjected to press-bonding by the roller to transfer and form the specific structure possessed by the mold onto the curable composition. This is cured and released from the mold to obtain the antireflection film having a moth-eye structure as a target of the present invention.

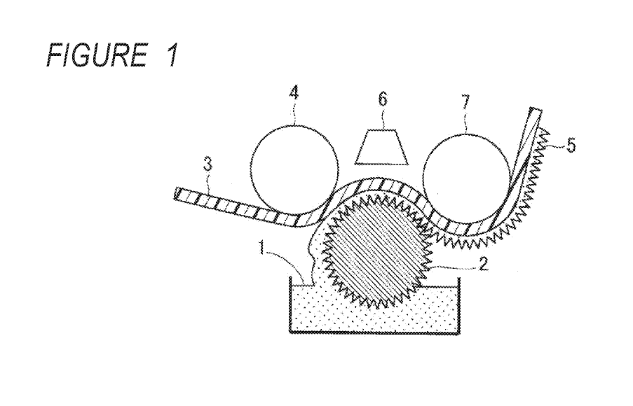

FIG. 1 is a schematic view of an exemplary apparatus for continuously manufacturing an antireflection film having a moth-eye structure, but the present invention is not limited thereto. That is, a curable composition 1 is attached to a mold 2, a force is given by a roller 4, and a transparent substrate film 3 is laminated to the mold from an oblique direction to transfer the specific structure possessed by the mold 2 onto the curable composition 1. This is cured by using a curing device 6, and then, peeled off from the mold 2 to obtain an antireflection film 5 having a moth-eye structure as a target of the present invention. A supporting roller 7 is configured to lift the antireflection film 5 having the moth-eye structure upwards.

The material is laminated from an oblique direction by using the roller 4 so that the antireflection film 5 having the moth-eye structure having no defect without bubbles may be obtained. Also, when the roller is used, a linear pressure is given. Thus, the pressure may be enlarged, so that it is possible to produce the antireflection film having the moth-eye structure with a large surface area and the control of the pressure becomes easy. Also, when the antireflection film 5 having the moth-eye structure is placed in a film state, it is possible to produce the antireflection film having a moth-eye structure with a uniform film thickness and predetermined optical properties, which is integrated with the transparent substrate film, and further it becomes excellent in productivity since it may be produced continuously.

The antireflection film having a moth-eye structure of the present invention may be polymerized by light irradiation, electron beam irradiation and/or heating. The wavelength of the light in the light irradiation is not particularly limited. It is preferred that the light contains the visible light and/or the ultraviolet ray because the carbon-carbon double bonds of the (meth)acryl group are satisfactorily polymerized in the presence of the photopolymerization initiator, if necessary. Particularly preferred is the light containing the ultraviolet ray. A light source is not particularly limited, and conventionally known light sources such as an ultra-high pressure mercury lamp, a high pressure mercury lamp, a halogen lamp, an electrodeless lamp and various lasers may be used. In the case of the electron beam irradiation, the intensity and the wavelength of the electron beam are not particularly limited, and conventionally known methods may be used.

When the polymerization is carried out by heat, the temperature is not particularly limited, but is preferably 80° C. or more, particularly preferably 100° C. or more. Also, it is preferably 200° C. or less, and particularly preferably 180° C. or less. If the polymerization temperature is too low, the polymerization does not proceed sufficiently in some cases. If it is too high, the polymerization becomes non-uniform or deterioration of the transparent substrate film occurs in some cases. The heating time is not also particularly limited, but is preferably 5 sec or longer, particularly preferably 10 sec or longer. Also, it is preferably 10 min or shorter, particularly preferably 2 min or shorter, further preferably 30 sec or shorter.

(A) Formation of Antifouling Layer by Atmospheric Pressure Plasma Treatment

In an atmospheric pressure plasma treatment, an antifouling layer is formed on a transparent substrate film (on an unevenness structure in the present invention) by plasma generated through discharge by supplying a reaction gas (also referred to as a reactive gas) into a gap between opposite electrodes under an atmospheric pressure or a pressure near the atmospheric pressure.

As for the atmospheric pressure plasma treatment applicable to the formation of the antifouling layer, technologies disclosed in, for example, Japanese Patent Laid-Open Publication No. H11-133205, Japanese Patent Laid-Open Publication No. 2000-185362, Japanese Patent Laid-Open Publication No. H11-61406, Japanese Patent Laid-Open Publication Nos. 2000-147209, and 2000-121804 may be exemplified.

In the atmospheric pressure plasma treatment disclosed in these publications, a pulsed electric field with a frequency of 0.5 kHz to 100 kHz, and an electric field intensity of 1 V/cm to 100 V/cm is applied between opposite electrodes to generate discharge plasma.

Here, an atmospheric pressure or a pressure near the atmospheric pressure ranges from about 20 kPa to 200 kPa, and preferably ranges from 93 kPa to 110 kPa in order to obtain satisfactory effects described in the present invention.

Details of an apparatus for the atmospheric pressure plasma treatment used in the present invention are described in Japanese Patent Laid-Open Publication No. 2007-176667.

In the formation of the antifouling layer, as a raw material gas for forming the antifouling layer, an organosilicon compound, a silicon hydride compound, and a halogenated silicon compound may be exemplified. As for the organosilicon compound, tetraethyl silane, tetramethyl silane, tetraisopropyl silane, tetra-butyl silane, tetraethoxysilane, tetraisopropoxysilane, tetrabutoxy silane, dimethyl dimethoxy silane, diethyl diethoxy silane, diethyl silane diacetoacetonate, methyltrimethoxysilane, methyltriethoxysilane, and ethyltriethoxysilane may be exemplified, as for the silicon hydride compound, tetra-hydrogenated silane, and hexa hydrogenated disilane may be exemplified, and as for the halogenated silicon compound, tetrachlorosilane, methyltrichlorosilane, and diethyl dichlorosilane may be exemplified. All of these may be preferably used in the present invention.

In the atmospheric pressure plasma treatment, under an atmospheric pressure or a pressure near the atmospheric pressure, a mixed gas consisting of a discharge gas, and a thin film forming gas which contains a compound containing fluorine atoms in 20% by mass or more, for example, a fluorine-atom containing organometallic compound is introduced into a discharge space and excited, and a polyester transparent substrate film having an optical thin film is exposed to the excited mixed gas so that an antifouling layer is formed on the optical thin film.

As for an apparatus for the atmospheric pressure plasma treatment which may be used in the formation of the antifouling layer, for example, technologies disclosed in, for example, Japanese Patent Laid-Open Publication No. H11-133205, Japanese Patent Laid-Open Publication No. 2000-185362, Japanese Patent Laid-Open Publication No. H11-61406, Japanese Patent Laid-Open Publication Nos. 2000-147209, and 2000-121804 may be exemplified. Also, as for a specific apparatus configuration, the apparatus or electrode applicable to the formation or processing in the above described antireflection layer or the pre-treatment, as described in FIGS. 1 to 5 of Japanese Patent Laid-Open Publication No. 2007-176667 may be employed.

As for the fluorine-atom containing compound used in the present invention, a fluorine-atom containing silane coupling agent is preferred. The silane coupling agent preferably used in the present invention is not particularly limited as long as an elemental composition of the surface formed with a film according to XPS falls within a specific range defined in the present invention. The silane coupling agent preferably has a substituent in which fluoroalkyl groups are linked by oxygen in the molecular structure, and a fluoroether-based perfluoroalkoxy perfluoroalkoxy triisopropoxysilane may be exemplified. This is preferred in view of forming a low friction thin film which is thin and has a high film strength because an oxygen atom is contained in the substituent so that the substituent has a flexible structure. As for the silane coupling agent, for example, OPTOOL DSX (manufactured by DAIKIN INDUSTRIES, LTD.), and CYTOP (manufactured by ASAHI GLASS CO., LTD.) are commercially available. When the silane coupling agent is used as the thin film forming gas according to the present invention, these compounds are vaporized to be supplied.

In a water and oil repellent treatment, a fluorine-containing alkoxysilane, or an alkoxysilane having a polydimethyl siloxane unit in the molecule is preferably used. As for the fluorine-containing alkoxysilane, KP-801M of a fluoroalkyl group-containing oligomer (manufactured by Shin-Etsu Chemical Co., Ltd.), X-24-7890 (manufactured by Shin-Etsu Chemical Co., Ltd.), KBM-7103 (trifluoropropyl trimethoxy silane, manufactured by Shin-Etsu Chemical Co., Ltd.), SIH5841.5 (heptadecafluoro-1,1,2,2,-tetrahydro decyltrimethoxysilane, manufactured by Gelest), and SIH5841.2 (heptadecafluoro-1,1,2,2-tetra hydrodecyl tetrahydrodecyl triethoxysilane, manufactured by Gelest) may be exemplified. Also, as for the alkoxysilane having a polydimethyl siloxane unit in the molecule, KPN-3504 (manufactured by Shin-Etsu Chemical Co., Ltd.), DMS-XE11 (ethoxy-terminated polydimethylsiloxane, manufactured by Gelest), DMS-XM11 (methoxy-terminated polydimethylsiloxane, manufactured by Gelest), DMS-S12, -S14, and -S15 (silanol-terminated polydimethylsiloxane) may be exemplified.

In a case of the formation of the antifouling layer by the atmospheric pressure plasma treatment, the antifouling layer is included as the uppermost layer in the region in a range of 0.1 nm to 5 nm from the surface of the unevenness structure to the transparent substrate film side (the inside), and it is preferred that the content ratio of fluorine atoms to oxygen atoms in the antifouling layer (hereinafter, abbreviated as F/O) ranges from 1.0 to 5.0, or the content ratio of silicon atoms derived from a silicone compound to oxygen atoms (for example, which may be calculated from a chemical shift of the silicon atoms in XPS measurement) (hereinafter, abbreviated as DSi/O) ranges from 1.0 to 5.0. When F/O or DSi/O is less than 1.0, the amount of a fluorine compound or a silicone compound locally present on the surface of the antifouling layer is too small so that a required antifouling property may not be imparted. When F/O or DSi/O is greater than 5.0, the amount of a fluorine compound or a silicone compound locally present on the surface of the antifouling layer is too large, so that the film strength of the outermost surface, itself, becomes weak, resulting in a degradation of durability of the antifouling property. Accordingly, it is possible to obtain an antireflection film having an antifouling layer useful for a liquid crystal image display device, various display devices, an organic EL display, a CRT, and a PDP, which is excellent in a thin film adhesion, a durability and an anti-reflective performance

(B) Formation of Antifouling Layer by Wet Coating

In the antifouling layer formed by wet coating in the present invention, materials described in the curable composition for forming the moth eye unevenness structure as described above may be properly used in combination.

In view of the optical performance, it is preferable to form the antifouling layer in the present invention by applying an antifouling layer forming composition through a method in which a plate does not physically touch a transparent substrate film or a mold, such as a die coating method, a spray method, a dip coating method, an inkjet method, an air knife coating method, a curtain coating method, and a slit scanning method, among generally well-known coating methods by wet coating.

In the formation of the antifouling layer by wet coating, the antifouling layer is included as the uppermost layer in the region in a range of 0.1 nm to 5 nm from the surface of the unevenness structure to the transparent substrate film side (the inside), and it is preferred that the content ratio of fluorine atoms to carbon atoms in the antifouling layer (hereinafter, abbreviated as F/C) ranges from 0.20 to 1.0, or the content ratio of silicon atoms derived from a silicone compound to carbon atoms (which may be calculated from a chemical shift of the silicon atoms) (hereinafter, abbreviated as DSi/C) ranges from 0.20 to 1.0. When F/C or DSi/C is less than 0.20, the amount of a fluorine compound or a silicone compound locally present on the surface of the antifouling layer is too small so that a required antifouling property may not be imparted. When F/C or DSi/C is greater than 1.0, the amount of a fluorine compound or a silicone compound locally present on the surface of the antifouling layer is too large, so that the film strength of the outermost surface, itself, becomes weak, resulting in a degradation of durability of the antifouling property. Accordingly, it is possible to obtain an antireflection film having an antifouling layer useful for a liquid crystal image display device, various display devices, an organic EL display, a CRT, and a PDP, which is excellent in a thin film adhesion, a durability and an anti-reflective performance

A material for a transparent substrate film in the present invention is preferably selected from inorganic materials or resins which contain inorganic materials. As for the inorganic materials, metals (e.g., Ni, Cu, Cr, Fe, Au, Ag), metal oxides (e.g., ITO, SnO₂, SiO₂, ZnO₂, Al₂O₃ and composite oxides thereof, quartz, glass), and metal nitrides (e.g., silicon nitride, boron nitride, titanium nitride, gallium nitride) may be exemplified. As for the resins, a polyester resin, an acrylic resin, an urethane resin, a vinyl chloride resin, an epoxy resin, a melamine resin, a fluorine resin, a silicone resin, a butyral resin, a phenol resin, a vinyl acetate resin, a cellulose resin, a polycarbonate resin, a polyimide resin and copolymers or modified products thereof may be exemplified. The performance or use of the transparent substrate film is suitable for an optical film, a phase difference film, a deposited film, a magnetic film, a reflective film, an antireflective film, a TFT array transparent substrate film, a PDP electrode plate, a conductive substrate, an insulating substrate. Also, the transparent substrate film to be used may be obtained by forming a layer made of organic and/or inorganic material on the materials exemplified as described above. The type of the transparent substrate film may be a plate type or a roll type.

Light to be used for curing the curable composition in the present invention is not specifically limited, but light or irradiation such as high-energy ionizing radiation, near-ultraviolet rays, far-ultraviolet rays, visible rays, infrared rays may be exemplified. The UV ray is particularly preferred in view of the versatility or energy amount of a light source.

Then, descriptions will be made on a process of bringing a layer made of a curable composition into contact with a mold or a transparent substrate film and sandwiching the layer between the transparent substrate film and the mold, and a process of curing the layer made of the curable composition, in the manufacturing method of the antireflection film of the present invention. In the present invention, when the fine pattern is manufactured through optical imprinting using the curable composition, it is required to select a light-transmitting material as for at least one of a mold material and/or a transparent substrate film. In a first method of the optical imprinting to be applied to the present invention, after a layer made of a curable composition is sandwiched between the transparent substrate film and the light-transmitting mold, the curable composition for imprinting is cured by irradiating light at the back surface of the light-transmitting mold. In a second method, after a layer made of a curable composition is sandwiched between the transparent substrate film and the mold, the curable composition for imprinting is cured by irradiating light at the back surface of the transparent substrate film. The 1st and the 2nd method may also be performed one by one or simultaneously. The light irradiation is preferably carried out in a state where the mold is attached, or may be performed after mold release.

As for a mold which may be used in the present invention, a mold having a pattern to be transferred is used. Although the mold can form a pattern by, for example, a photo lithography, or an electron beam drawing method according to a desired processing accuracy, the mold pattern formation method is not particularly limited in the present invention. Moreover, it is also possible to use a mold obtained by transferring and reproducing a basic mold. A mold is preferably selected from inorganic materials or resins which contain inorganic materials.

It is preferable to use the anodized porous alumina obtained by anodizing aluminum as for the mold for forming the so-called moth eye that shows antireflection performance. The manufacturing method of the mold of anodized porous alumina is described in Japanese Patent Laid-Open Publication No. 2003-43203 or 2008-209867. As for a material which may be used for a mold, those exemplified as a material which may be used for the above-mentioned transparent substrate film may be used.

As for the light-transmitting mold material used at the time of light irradiation at the mold side in the present invention, light-transmitting inorganic materials (e.g., metal oxides such as glass, quartz, quartz glass), light-transmitting organic resins (e.g., PMMA, polycarbonate resin), a transparent metal deposition film, a light-transmitting flexible film such as polydimethylsiloxane, and a light-transmitting photo-cured film may be exemplified. Especially the material that forms a mold is preferably an inorganic material from the viewpoint of the durability at the time of repetitive uses, the formation accuracy, and the ease of a mold processing, and is particularly preferably a metal oxide (e.g., glass, quartz, alumina). The type of the mold that may be used in the present invention may be either a plate type or a roll type. The roll-type mold is applied particularly when a continuous production of transfer is required. In the manufacturing method of the present invention, the continuous production using the roll-type mold is effective because the mold dirt at the time of repetitive uses is improved.

In the present invention, it is also preferred to perform a release treatment on the surface of a mold. Through the release treatment, a good releasing property may be maintained without containing a releasing agent.

When an anodized film formed on the surface of an aluminum substrate (hereinafter, referred to as an “Al substrate”), as it is, is used as for a moth eye mold, there is a problem in that a rigidity and/or a processability (e.g., machinability) is low. For example, even when an anodized film is formed over a high-purity aluminum plate, such as an aluminum plate of 99.99% (or “4N”) described in Japanese Patent Laid-Open Publication No. 2005-156695, a practical moth eye mold cannot be obtained from the aluminum plate with a thickness of several millimeters to several tens of centimeters, because of its low rigidity. Of course, the rigidity of the plate may be increased by increasing the thickness of the aluminum plate. However, this solution causes various wastes, typically waste of source materials, and thus is not applicable to mass production.

Meanwhile, in the present specification, an “Al substrate” does not include a thin film of Al, but refers to Al in bulk which is self-supporting and which is in the form of a plate with a thickness of not less than 2 mm, or in the form of a circular cylinder or circular column.

Meanwhile, when an aluminum plate which contains an impurity element (e.g., JIS 1050 (aluminum purity: 99.50% by mass or more)) is used in order to obtain the sufficient rigidity and processability, pits (concave portions) larger than the above-described micropores are formed. This may not be used for formation of a moth-eye structure with excellent antireflection characteristics.

The following method is preferable as a method of manufacturing a mold of an Al substrate formed with an anodized film, the mold, as it is, being applicable to a moth-eye structure forming mold.

In the manufacturing method of a mold of the present invention, a moth-eye structure is formed over a surface, the moth-eye structure including a plurality of first convex portions each of which has a two-dimensional size of not less than 10 nm and less than 500 nm when seen in a normal direction of the surface. The method includes: (a) preparing an Al substrate in which an Al content is less than 99.99% by mass; (b) partially anodizing the Al substrate to form a porous alumina layer which has a plurality of very fine concave portions; (c) after step (b), allowing the porous alumina layer to be in contact with an etchant which contains an anodic inhibitor, thereby enlarging the plurality of very fine concave portions of the porous alumina layer; and (d) after step (c), further anodizing the Al substrate to grow the plurality of very fine concave portions. In the moth-eye structure, the distance between adjacent first convex portions is preferably not less than 30 nm and less than 600 nm.

In the mold manufacturing method used in the present invention, instead of using the etchant which contains the anodic inhibitor (countermeasure a), an Al substrate may be used in which the content of an element whose standard electrode potential is higher than Al is 10 ppm or less, and the content of an element whose standard electrode potential is lower than Al is not less than 0.1 mass % (countermeasure b). Alternatively, a step of forming an additional barrier layer of alumina may be further performed before step (c) (countermeasure c). Alternatively, any two or more of the above three countermeasures a to c may be employed in combination. Further, it is possible to use an etchant which contains a compound capable of forming a film over the surface of the Al substrate, in place of or together with the anodic inhibitor.

After step (d), step (c) and step (d) are further performed. Meanwhile, a series of the steps preferably ends with the anodization step (the step of growing the very small concave portions). However, it may end with the etching step (the step of enlarging the very small concave portions).

The Al substrate contains at least one element selected from the group consisting of Fe, Si, Cu, Mn, Zn, Ni, Ti, Pb, Sn and Mg.

In the Al substrate, the content of an element whose standard electrode potential is higher than Al is 10 ppm or less, and the content of an element whose standard electrode potential is lower than Al is not less than 0.1 mass %.

The Al substrate contains Mg in a range of 0.1 mass % to 7.0 mass %.

The anodic inhibitor is organic.

The etchant contains a compound which forms a film over a surface of the Al substrate.

The etchant contains an organic acid. Preferably, both the acid and the anodic inhibitor are organic.

The method further includes, before step (c), forming an additional barrier layer of alumina.

The method further includes, before step (b), imparting an uneven shape to a surface of the alumina transparent substrate film, the uneven shape including a plurality of second convex portions each of which has a two-dimensional size in a range of 0.1 μm to 100 μm. In the unevenness structure, the distance between adjacent second convex portions preferably ranges from 0.1 μm to 100 μm.

A method of producing an antireflection film according to the present invention, includes: preparing a mold fabricated according to any of the fabrication methods as set forth above and a curable composition; and forming the moth-eye structure over a surface of the curable composition using the mold.

The method includes the step of curing a photo-curable resin interposed between the mold and the surface of the curable composition, thereby forming a photo-curable resin layer formed with the moth-eye structure over the surface of the workpiece.

For the mold used for the antireflection film of the present invention, the method specifically described in WO10/73636 may be properly used.

In a method for providing an antifouling layer to the antireflection film of the present invention, when the (A) atmospheric pressure plasma treatment or (B) the wet coating method as described above is used, in a case of (A), since the aspect ratio of the unevenness is not largely changed before and after the antifouling layer is provided, the aspect ratio preferably ranges from 1.0 to 3.0, more preferably from 1.5 to 2.5, and is still more preferably 2.0.

In a case of (B), since the aspect ratio of the unevenness is changed to be smaller before and after the antifouling layer is provided, the aspect ratio of the mold needs to be large from the beginning, and thus the aspect ratio preferably ranges from 1.1 to 5.0.

When the imprinting is performed using the curable composition of the present invention, the pressure of a mold is usually preferably at 10 atm or less. It is preferable that the mold pressure is set to 10 atm or less, because the mold or the transparent substrate film is hardly deformed, so that the pattern accuracy may be improved, and also the apparatus size may be reduced due to a low pressure. The pressure of the mold is adjusted so that the curable composition for nanoimprinting may be sufficiently widely spread over the mold concave portions.

When, in a decompression state before the mold is pressurized, the mold pressurization and exposure are performed, bubble incorporation, and reactivity reduction caused by oxygen incorporation may be effectively suppressed. In this view, it is preferable that in a decompression state, the mold is pressurized. In the present invention, a preferable degree of vacuum is performed in the range of normal pressure from 10-1 Pa. In order to further decrease inhibition of the radical polymerization by oxygen during curing, an inert gas such as nitrogen or argon is allowed to flow so that the oxygen concentration becomes 10% or less, preferably 5% or less, or 1% or less. In view of the productivity, it is preferable that the pressurization is performed at the atmospheric pressure, as it is. Any method convenient for a process design may be suitably selected.

In the light irradiation for the optical imprint lithography in the present invention, the exposure intensity preferably ranges from 1 mW/cm² to 50 mW/cm². When the intensity is 1 mW/cm² or more, the exposure time may be reduced, thereby improving the productivity, and when the intensity is 50 mW/cm² or less, a deterioration of permanent film characteristics due to the occurrence of a side reaction may be suppressed. The exposure amount preferably ranges from 5 mJ/cm² to 1000 mJ/cm². When the exposure amount is 5 mJ/cm² or more, an exposure margin becomes narrow, so that a problem such as adhesion of unreacted substances to a mold due to insufficient photo-curing may be suppressed from occurring. When the exposure amount is 1000 mJ/cm² or less, the permanent film may be suppressed from being deteriorated due to decomposition of the composition. The light irradiation may be performed in a plurality of steps.

In the optical imprinting employed in the present invention, the light irradiation is generally performed at a room temperature, but may be performed at a controlled temperature to control the reactivity. The temperature preferably ranges from 5° C. to 120° C., and more preferably from 15° C. to 80° C. The temperature may be controlled by controlling the temperature of the transparent substrate film and/or the mold.

When the curable composition in the present invention contains a thermal polymerization initiator, the curing may be initiated by increasing the temperature of the transparent substrate film and/or the mold. The temperature preferably ranges from 150° C. to 280° C., and preferably from 200° C. to 250° C. Also, the time for heating preferably ranges from 5 min to 60 min, and more preferably from 15 min to 45 min.

In the present invention, after the optical-curing or thermal-curing, the mold is released from the curable composition for nano-imprinting. Here, it is ideal that the mold release is carried out only by removing the mold pressure and separating the mold from the transparent substrate film. When the mold is not released only by separating from the transparent substrate film, the release may be promoted through, for example, vibration caused by ultrasonic waves.

In the present invention, it is preferred to add a step of advancing the curing of the curable composition after the release from the mold. Specifically, the transparent substrate film having a fine pattern may be further irradiated with light or heated. In a case of a radical polymerization, a polymerization inhibition may be decreased by employing a low oxygen environment as mentioned above. It is preferable to perform a step of further curing through heating (post-baking step). When the curable composition of the present invention is heated and cured after the light irradiation, the heating temperature preferably ranges from 150° C. to 280° C. and more preferably from 200° C. to 250° C. Also, the heating time preferably ranges from 5 min to 60 min, and more preferably from 15 min to 45 min.

It is preferable to use the post-baking step since an organometallic compound serving as an adhesion improving agent is suppressed from reacting with the mold but reacts with the transparent substrate film.

The transparent substrate film having a fine pattern of the present invention may be used for an optical lens sheet, a lens array, a prism sheet, a scattering sheet, an antireflection sheet, a color filter, an overcoat layer, and a timber. Also, it may be used as for a mold for forming these members or an intermediate mold for creating a mold.

The transparent substrate film having a fine pattern of the present invention may be, for example, a transparent substrate film having a fine pattern which may be manufactured by the manufacturing method of the present invention. The fine pattern of the present invention preferably has a composition distribution in a direction perpendicular to the transparent substrate film, in the layer made of the cured curable composition. According to one preferred aspect of the transparent substrate film having a fine pattern of the present invention, the content of the fine particles is distributed in a direction perpendicular to the transparent substrate film in the layer made of the cured curable composition.

According to another preferred aspect of the transparent substrate film having a fine pattern of the present invention, the content of monomers for adjusting a refractive index is distributed in a direction perpendicular to the transparent substrate film in the cured curable composition.

The layer made of the curable composition is formed as a layer obtained by curing the curable composition which contains polymerizable monomers for adjusting a refractive index, which is preferably formed on the plane in a direction perpendicular to the transparent substrate film in a normal direction with respect to the surface opposite (the mold side) to the transparent substrate film. The thickness preferably ranges from 10 nm to 5 μm, more preferably from 30 nm to 2 μm, and still more preferably from 60 nm to 1 μm. Within this range, a refractive index variation within a fine unevenness pattern is reduced and thus it is possible to easily exhibit an intended optical design, and to satisfy the pattern accuracy, the mold releasing property, and the strength of a cured film in a balanced manner

The above described distribution of fine particles and/or refractive index adjusting monomers in the cured film may be obtained by analyzing the laminated film of the transparent substrate film having the fine pattern after the mold release. An analysis portion is not limited to a specific portion of the pattern shape. However, the analysis may be easily performed using a substantially flat region (beyond 0.1 μm angle) on the surface of the layer made of the curable composition. The measurement method of the compound distribution is not limited. For example, a section of the cured layer may be created and then observed through a light transparency electron microscope in the case of fine particles. Also, in a case of the refractive index adjusting monomers, the observation may be easily performed by TOF-SIMS. For example, the measurement may be performed under the following conditions.
Device: TRIFTII, manufactured by Physical Electronics (PHI)
Primary ion; Ga+ (15 kV)
Aperture: No. 3 (Ga+ current amount: equivalent to 600 pA)
Mapping mark: 256×256 points
Detected secondary ion mass: 0 amu to 1000 amu [amu; atom mass unit]
Integration time: 60 min

The transparent substrate film having a fine pattern of the present invention may be used for an optical lens sheet, a lens array, a prism sheet, a scattering sheet, an antireflection sheet, a color filter, an overcoat layer, and a timber. Also, it may be used as for a mold for forming these members or an intermediate mold for creating a mold.

[Display Device]

The display device of the present invention is not particularly limited as long as it has a fine pattern obtained by curing the curable composition in the present invention as described above. Examples of the display device may include a liquid crystal display device, a plasma display device, an EL display device, and a CRT display device. The definitions of display devices and explanation of each display device are described in, for example, “Electronic Display Device (Akio Sasaki, published by Kogyo Chosakai Publishing Co., Ltd. in 1990)”, and “Display Device (Sumiaki Ibuki, published by Sangyo Tosho K. K. in 1989)”.

As for the display device of the present invention, a liquid crystal display device is preferred. The liquid crystal display device is described in, for example, “Next Generation Liquid Crystal Display Techniques (edited by Tatsuo Uchida, published by Kogyo Chosakai Publishing Co., Ltd. in 1994).” The liquid crystal display device to which the present invention is applicable is not particularly limited, and for example, the present invention may be applicable to various types of liquid crystal display devices described in “Next Generation Liquid Crystal Display Techniques” above. Above all, the present invention is effective particularly in a color TFT-type liquid crystal display device. The color TFT-type liquid crystal display device is described in, for example, “Color TFT Liquid Crystal Display (published by KYORITSU SHUPPAN CO., LTD. in 1996).” Also, the present invention may be applied to a liquid crystal display device with a wider viewing angle, such as a transverse electric field driving type (e.g., IPS), or a pixel division type (e.g., MVA). These types are described on, for example, page 43 of “EL, PDP, LCD Display-Latest Trends of Technology and Markets-(published by Research Study Division of TORAY Research Center, Inc., in 2001).”

The liquid crystal display device is constituted by various members such as a color filter, an electrode substrate, a polarizing film, a phase difference film, a back light, a spacer, a viewing angle compensating film, an antiglare film, and an antireflection film. These members are described in, for example, “Market of Liquid Crystal Display-related Materials and Chemicals in 1994 (Kentaro Shima, published by CMC Publishing CO., LTD. in 1994)”, and “Current Status and Future Prospect of Liquid Crystal-related Market in 2003 (2nd vol.) (Ryokichi Omote, published by Fuji Chimera Research Institute, Inc. in 2003).”

The liquid crystal display device of the present invention may employ various display modes such as ECB (Electrically Controlled Birefringence), TN (Twisted Nematic), IPS (In-Plane Switching), FLC (Ferroelectric Liquid Crystal), OCB (Optically Compensatory Bend), STN (Supper Twisted Nematic), VA (Vertically Aligned), HAN (Hybrid Aligned Nematic), GH (Guest Host).

### EXAMPLES

The present invention will be described in more detail with reference to Examples below. For example, materials, use amounts, ratios, processing contents, and processing sequences described in Examples below may be properly changed without departing from the spirit of the present invention. Accordingly, the scope of the present invention is not limited to the specific examples described below.

### Example 1

[Manufacturing of an Antireflection Film Having a Moth-Eye Structure]

Polyethylene glycol diacrylate (a) (53 g) when m=24 (m represents the number of repeating units of ethyleneglycol) in “polyethylene glycol diacrylate represented by Formula (2) below” included in Formula (1) above, urethane acrylate (a) (40 g) represented by Formula (a) below, which is obtained by bonding isophoronediisocyanate to two dipentaerythritolpentaacrylates, 1-hydroxycyclohexyl phenyl ketone (5 g) as for a photopolymerization initiator, and IPA-ST (3 g) as an improving agent for adhesion to an antifouling layer were sufficiently stirred and mixed to obtain a curable composition A-1.

Meanwhile, the solvent in the dispersion of fine particles was evaporated at a room temperature until the concentration in a curable composition becomes 0.5% by mass or less. The amount of the fine particles in Table 1 represents parts by mass of a non-volatile content excluding the solvent.

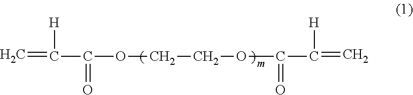

In Formula (2), m represents a natural number.

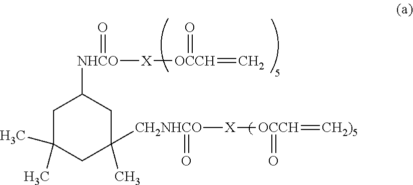

In Formula (a), X represents a dipentaerythritol (having 6 hydroxyl groups) residue. Then, an appropriate amount of the composition was collected and applied onto a triacetyl cellulose film (TD60UL, manufactured by Fujifilm Corporation) by a gravure roll coater to have a uniform film thickness. Thereafter, a mold having a structure in which convex portions having an average height of 205 nm had been arranged with an average cycle of 150 nm on the surface thereof was bonded thereto. Confirming that the entire mold was bonded to the curable composition, the composition was fully cured by irradiating ultraviolet rays at 800 mJ/cm² using an UV irradiation device manufactured by Fusion Inc., and the mold was released to produce a moth-eye layer substrate film A-1 with an average film thickness of 11 μm which had a moth-eye structure. In the moth-eye structure, an average height was 183 nm, an average cycle was 175 nm, and an aspect ratio was 1.0.

Meanwhile, the reaction rate of the moth-eye layer substrate film was 80% when measured by ATR-IR.

(Formation of Antifouling Layer B-1)

The moth-eye layer substrate film A-1 having the moth-eye structure was subjected to a pre-treatment using a discharge device including a pair of roll electrodes as described in FIG. 5 of Japanese Patent Laid-Open Publication No. 2007-17667, in which the film was exposed to a discharge space for 1 sec (a gap between the pair of roll electrodes: 1 mm, a discharge gas: nitrogen gas/oxygen gas=80/20 (vol % ratio)). Meanwhile, the power supply frequency of the high frequency power source was 10 kHz and was applied to a second electrode as at an output density of 5.0 W/cm². Subsequently to the pre-treatment step, the antifouling layer was formed online.

A mixed gas of a discharge gas and a thin film forming gas as described below was supplied at a volume ratio of 1:1 to the discharge space constituted by a pair of roll electrodes described in FIG. 5 of Japanese Patent Laid-Open Publication No. 2007-17667, and a high frequency voltage was applied to excite the mixed gas. The moth-eye substrate film A-1 having the moth-eye structure, which was subjected to the pretreatment, was exposed to the excited mixed gas to form an antifouling layer with an optical film thickness of 0.5 nm, and then an antireflection film sample No. 1 having a moth-eye structure was manufactured. In the moth-eye structure, an average height was 165 nm, an average cycle was 150 nm, and an aspect ratio was 1.1.

<Discharge Gas>

Nitrogen gas 98.5% by volume

Hydrogen gas 1.5% by volume

<Thin Film Forming Gas>

Nitrogen gas 99.8% by volume

Organometallic compound (heptadecafluorodecyl triisopropoxysilane): 0.2% by volume (vaporized in a nitrogen gas by a vaporizer manufactured by The Estec Co., Ltd.)

<Electrode>

As for the electrodes, titanium was used, and alumina ceramic was sprayed and coated to 1 mm on the surfaces of the electrodes constituting the discharge space. Then, a coating liquid having an alkoxysilane monomer dissolved in an organic solvent was coated on the alumina ceramic film, dried, heated at 150° C., and was subjected to a sealing treatment to form a dielectric. The portion of the electrode which was not covered with the dielectric was connected to the high frequency power source or grounded to earth. Meanwhile, a gap between a gas outlet and the transparent substrate film was 1 mm

The power supply frequency of the high frequency power source was 10 kHz, and was applied to a second electrode at an output density of 5.0 W/cm².

(Manufacturing of Cleaning Cloth A)

Polyethylene terephthalate (PET) (intrinsic viscosity 0.71 m³/kg) as an island component, and PET copolymerized with 5-sodium sulfoisophthalic acid (7.3% by mass, intrinsic viscosity 0.55 m³/kg) as a sea component were melt-spun using a sea/island type composite spinneret (the number of islands: 127, the number of holes: 112) under conditions such as an island component ratio of 30% by mass, a spinning temperature of 290° C., and a winding speed of 1500 m/min to obtain non-stretched fibers. Then, the resultant non-stretched fibers were stretched under conditions such as a winding speed of 500 m/min, a preheating temperature of 90° C., and a heat setting temperature of 160° C. to obtain a sea/island type composite fiber of 44 dtex-112 filaments (fiber 1).

Meanwhile, melt-spinning was performed in the same manner as in fiber 1 except that as for an island component, polypropyleneterephthalate (PPT) (intrinsic viscosity: 1.14 m³/kg) was used. The resultant non-stretched fibers were stretched under conditions such as a winding speed of 500 m/min, a stretching temperature of 90° C., and a heat setting temperature of 100° C. to obtain a sea/island type composite fiber of 75 dtex-112 filaments (fiber 2). A difference in the time for completely removing the sea component in the resultant fibers 1 and 2 was 4%.

The resultant fibers 1 and 2 were commingled by interlacing, and immersed in an aqueous sodium hydroxide solution of 80° C. (2% by mass), so that the sea component was dissolved and removed, and a temporary contracting treatment was performed. Then, the fibers were immersed in a boiling water of 98° C. and dried so as to complete the contraction. In the resultant nanofiber-combined filament yarn, the fiber diameter of the fiber 1 was 280 nm, the fiber diameter of the fiber 2 was 290 nm, a deviation of a length between fibers was 10%, and an elongation elastic modulus at 20% elongation was 85%. The resultant nanofiber-combined filament yarn was highly excellent in single fiber dispersibility, and the fabric made of the resultant nanofiber-combined filament yarn was excellent in both a wiping performance and a scratch performance, and thus had an enough performance in use as a product. The fiber diameter of the nanofiber-combined filament yarn and the void of the cleaning cloth were obtained by observing the shape through a scanning electron microscope, randomly drawing a straight line from one end to the other end on the scanning electron microscopic photograph, and measuring and taking an average on the distance of adjacent voids on the straight line (n=50). The value was determined by rounding off to the numerical value of the first digit (less than 10 nm).

The fabric made of the resultant nanofiber-combined filament yarn was subjected to a corona discharge treatment (corona discharge electron irradiation amount: 34 W/m²/min) to prepare a cleaning cloth A. The void of the resultant cleaning cloth A was 290 nm, and the water contact angle to the cleaning cloth A was 30°.

(Manufacturing of Cleaning Cloth B)

The nanofiber-combined filament yarn was obtained in the same manufacturing method as in the cleaning cloth A except that the ratio of the island component was 15% by mass, and the fiber diameter of the fiber 1 was 140 nm, and the fiber diameter of the fiber 2 was 145 nm. In the fabric made of the nanofiber-combined filament yarn, a void of the cleaning cloth B after a corona discharge treatment was 145 nm, and a water contact angle to the cleaning cloth B was 20°.

(Manufacturing of Cleaning Cloth C)

The nanofiber-combined filament yarn was obtained in the same manufacturing method as in the cleaning cloth A except that the ratio of the island component was 45% by mass, and the fiber diameter of the fiber 1 was 430 nm, and the fiber diameter of the fiber 2 was 440 nm. In the fabric made of the nanofiber-combined filament yarn, a void of the cleaning cloth C after a corona discharge treatment was 440 nm, and a water contact angle to the cleaning cloth C was 40°.

In Samples No. 2 to 15 and 101, an appropriate amount of the curable composition having a composition noted in Table 1 was collected and applied onto a triacetyl cellulose film to have a uniform film thickness in the same manner as in sample No 1 of the antireflection film. Then, the mold was bonded thereto in the same manner as in sample No. 1, and polymerization was performed in the same manner to prepare each antireflection film having a moth-eye structure. Then, the atmospheric pressure plasma treatment was performed in the same manner as in sample No. 1. Meanwhile, the number unit in the curable composition in Table 1 is [g], and the number unit of the thin film forming gas is [vol %].

In sample No. 16, a moth-eye structure was manufactured through bonding and polymerization in the same manner as in sample No. 1 except that as for the mold, a mold having a structure in which convex portions with an average height of 410 nm were arranged at an average cycle of 150 nm was used.

Meanwhile, in sample No. 101 as Comparative Example, an antifouling layer was not formed.

TABLE 1

| Sample No. | 1 | 2 | 3 | 4 | 5 | 6 | 7 | 8 | 9 | 10 | 11 | 12 | 13 | 14 | 15 | 16 | 101 |
|---|---|---|---|---|---|---|---|---|---|---|---|---|---|---|---|---|---|
| Curable composition | A-1 | A-2 | A-3 | A-4 | A-5 | A-6 | A-3 | A-3 | A-3 | A-3 | A-3 | A-3 | A-7 | A-8 | A-9 | A-10 | A-101 |
| for moth eye layer | | | | | | | | | | | | | | | | | |
| Polyethylene glycol | 52 | | | | | | | | | | | | | | | 52 | |
| diacrylate(a) | | | | | | | | | | | | | | | | | |
| Polyethylene glycol | | 65 | 56 | 56 | 56 | 56 | 56 | 56 | 56 | 56 | 56 | 56 | 52 | | 52 | | 61 |
| diacrylate(b) | | | | | | | | | | | | | | | | | |
| Polyethylene glycol | | | | | | | | | | | | | | 52 | | | |
| diacrylate(c) | | | | | | | | | | | | | | | | | |
| Urethane acrylate(a) | 40 | 27 | 33 | 33 | 33 | 33 | 33 | 33 | 33 | 33 | 33 | 33 | 40 | 40 | | 40 | 36 |
| Urethane acrylate(b) | | | 3 | 3 | 3 | 3 | 3 | 3 | 3 | 3 | 3 | 3 | | | 40 | | 3 |
| 1-hydroxycyclohexyl | 5 | 5 | 5 | 5 | 5 | 5 | 5 | 5 | 5 | 5 | 5 | 5 | 5 | 5 | 5 | 5 | 5 |
| phenylketone | | | | | | | | | | | | | | | | | |
| IPA-ST | 3 | 3 | 3 | | | | 3 | 3 | 3 | 3 | 3 | 3 | 3 | 3 | 3 | 3 | |
| MEK-ST | | | | 3 | | | | | | | | | | | | | |
| IPA-ST-L | | | | | 3 | | | | | | | | | | | | |
| P-1 | | | | | | 3 | | | | | | | | | | | |
| Fluorine-based | | | | | | | | | | | | | | | | | 0.5 |
| surfactant(a) | | | | | | | | | | | | | | | | | |
| Thin film forming | B-1 | B-1 | B-1 | B-1 | B-1 | B-1 | B-2 | B-3 | B-4 | B-5 | B-6 | B-7 | B-1 | B-1 | B-1 | B-1 | — |
| gas for antifouling | | | | | | | | | | | | | | | | | |
| layer(vol %) | | | | | | | | | | | | | | | | | |
| Nitrogen gas | 99.8 | 99.8 | 99.8 | 99.8 | 99.8 | 99.8 | 99.95 | 99.8 | 99.6 | 99.95 | 99.8 | 99.6 | 99.8 | 99.8 | 99.8 | 99.8 | — |
| Heptadecafluoro | 0.2 | 0.2 | 0.2 | 0.2 | 0.2 | 0.2 | 0.05 | | | | | | 0.2 | 0.2 | 0.2 | 0.2 | — |
| decyltriiso- | | | | | | | | | | | | | | | | | |
| propoxysilane | | | | | | | | | | | | | | | | | |
| KBM-7103 | | | | | | | | 0.2 | 0.4 | | | | | | | | — |
| KPN-3504 | | | | | | | | | | 0.05 | 0.2 | 0.4 | | | | | — |
| Remarks | Ex. | Ex. | Ex. | Ex. | Ex. | Ex. | Ex. | Ex. | Ex. | Ex. | Ex. | Ex. | Ex. | Ex. | Ex. | Ex. | Comp. |
| | | | | | | | | | | | | | | | | | Ex. |

The compounds used in Table 1 are described below. Meanwhile, a refractive index of a polymerizable monomer indicates a refractive index after polymerization.

polyethylene glycol diacrylate(b): m=14 in Formula (2) above

polyethylene glycol diacrylate(c): m=9 in Formula (2) above

fluorine-based surfactant (a): p=8, q=10, R¹═F, R²═H, R³═H, X═—CH₂CH₂O— in Formula (F) below

fluorine-based surfactant (b): p=6, q=5, R¹═F, R²═H, R³═H, X═—CH₂CH₂O— in Formula (F) below

fluorine-based surfactant (c): p=6, q=10, R¹═F, R²═H, R³═H, X═—CH₂CH₂O— in Formula (F) below

R¹(CF₂)ₚ—XCHR²—CH₂—O_{q}R³ (F)

Urethane acrylate (b): in which three pentaerythritol triacrylates are bonded to a nurate product (trifunctional isocyanate) where hexamethylene diisocyanates are trimerized to form a 6-membered ring.

KBM-7103: trifluoropropyl trimethoxysilane, manufactured by Shin-Etsu Chemical Co., Ltd.

KPN-3504: alkoxysilane having a polydimethylsiloxane unit, manufactured by Shin-Etsu Chemical Co., Ltd.

IPA-ST: colloidal silica (average particle size about 10 nm, manufactured by Nissan Chemical Industries, Ltd., no surface treatment, particle refractive index 1.46)

MEK-ST: colloidal silica (average particle size about 10 nm, manufactured by Nissan Chemical Industries, Ltd., surface treatment of trimethylsilyl (KBM-13 manufactured by Shin-Etsu Chemical Co., Ltd.) in an amount of 30% with respect to particles, refractive index 1.46)

IPA-ST-L: colloidal silica (average particle size about 45 nm, manufactured by Nissan Chemical Industries, Ltd., no surface treatment, particle refractive index 1.46)

Particle (P-1): colloidal silica (average particle size about 10 nm, surface treatment of IPA-ST manufactured by Nissan Chemical Industries, Ltd., using 20% of pair particles of acryloyloxypropyltrimethoxysilane (KBM-5103 manufactured by Shin-Etsu Chemical Co., Ltd.), particle refractive index 1.46)

[Evaluation]

The resultant antireflection film having a moth-eye structure was evaluated by the following method. The results are noted in Table 2.

(Confirmation of Moth-Eye Structure)

The shape of the surface of the antireflection film was observed through a scanning electron microscope and evaluated. The cycle of the microstructure pattern was obtained by randomly drawing a straight line from one end to the other end on the scanning electron microscopic photograph, and measuring and taking an average on the distance between apexes of adjacent convex portions on the straight line (n=50). The value was determined by rounding off to the numerical value of the first digit (less than 10 nm).

(Specular Reflectance)

The back surface of the film was roughened with sandpaper, and treated with black ink so as to eliminate the back reflection. Then, a spectrophotometer V-550 (manufactured by JASCO Corporation) was mounted with an adapter ARV-474, and the specular reflectance was measured in a wavelength region of 380 nm to 780 nm, at an incident angle of 5°. The average reflectance was calculated and the antireflection property was evaluated.

(Surface Strength)

A friction part of a device reciprocating at a speed of 6 m/min (vibrating type friction fastness tester, AB-301 type, manufactured by TESTER SANGYO CO., LTD.) was attached with non-woven fabric (BEMCOT M-3, manufactured by Asahi Kasei Corporation), and an antireflection film was installed on a test piece pedestal. The friction part was reciprocated and rubbed with a load of 4.9 N/cm², and then evaluation was performed by the following criteria.

A: in the antireflection film, a change in the appearance was not recognized even after 30 reciprocations.

B: in the antireflection film, whiteness was slightly increased during 21 to 30 reciprocations.

C: in the antireflection film, whiteness was slightly increased during 11 to 20 reciprocations.

D: in the antireflection film, whiteness was slightly increased during 1 to 10 reciprocations.

E: in the antireflection film, whiteness was highly increased during 1 to 9 reciprocations.

(Evaluation of antifouling property)

The antireflection film having a moth-eye structure of the present invention was fixed on a glass substrate by an adhesive so that the antireflection layer side became an outermost surface. Under conditions of 25° C. and 60 RH %, a fingerprint was adhered on the antireflection layer surface, and then a fingerprint stain was clearly recognized with eyes from the front. After 10 sec, the fingerprint stain was wiped off by reciprocating a bundle of 10-ply cleaning cloths A to C and SAVINA (manufactured by KB SEIREN, LTD., void 1 μm) twice at a load at which the cloth bundle may be dent. Then, through observation of the fingerprint, the antifouling property was evaluated.

A⋅⋅⋅Fingerprint stain cannot be observed from the front or from the oblique direction.

B⋅⋅⋅Fingerprint stain cannot be observed from the front but slightly observed from the oblique direction.

C⋅⋅⋅Fingerprint stain cannot be observed from the front but observed from the oblique direction.

D⋅⋅⋅fingerprint stain can be observed from the front.

(Contact Angle)

A “contact angle” refers to a water contact angle or an oleic acid contact angle which is obtained through a tangent method by dropping water or oleic acid on an antireflection film having a moth-eye structure with an unevenness structure defined on the surface. The measurement of the contact angle was performed using a contact angle measurement device, DM-700, manufactured by Kyowa Interface Science Co., Ltd.

(Measurement of Fluorine Atom Content (F), Silicon Content (DSi), Oxygen Atom Content (O), Carbon Atom Content (C) of Antifouling Layer)

The number of atoms of fluorine, silicon, and oxygen in an antifouling layer of each optical film manufactured as described above was measured using an XPS surface analyzer, ESCALAB-200R manufactured by VG Scientific Co., Ltd., under the conditions described above, and at a measurement angel of 30° (measurement depth: 5 nm) to obtain a fluorine atom content (F), a silicon content (DSi), an oxygen atom content (0), and a carbon atom content (C). Meanwhile, the silicon content DSi was calculated from a peak intensity of combined silicon when a chemical shift (102 eV) occurs in a 2p spectrum of silicon atoms.

1) From the fluorine atom content (F), the silicon content (DSi), the oxygen atom content (0), and the carbon atom content (C) measured by the method above, F/0, DSi/O, F/C, or DSi/C was calculated.

TABLE 2

| Sample No. | 1 | 2 | 3 | 4 | 5 | 6 | 7 | 8 | 9 | 10 | 11 | 12 | 13 | 14 | 15 | 16 | 101 |
|---|---|---|---|---|---|---|---|---|---|---|---|---|---|---|---|---|---|
| Curable | A-1 | A-2 | A-3 | A-4 | A-5 | A-6 | A-3 | A-3 | A-3 | A-3 | A-3 | A-3 | A-7 | A-8 | A-9 | A-10 | A-101 |
| composition for | | | | | | | | | | | | | | | | | |
| moth eye layer | | | | | | | | | | | | | | | | | |
| Thin film | B-1 | B-1 | B-1 | B-1 | B-1 | B-1 | B-2 | B-3 | B-4 | B-5 | B-6 | B-7 | B-1 | B-1 | B-1 | B-1 | — |
| forming gas for | | | | | | | | | | | | | | | | | |
| antifouling layer | | | | | | | | | | | | | | | | | |
| Cycle of | 175 | 175 | 175 | 175 | 175 | 175 | 175 | 175 | 175 | 175 | 175 | 175 | 175 | 175 | 175 | 175 | 150 |
| unevenness | | | | | | | | | | | | | | | | | |
| structure | | | | | | | | | | | | | | | | | |
| Height/depth of | 183 | 183 | 183 | 183 | 180 | 184 | 183 | 183 | 181 | 183 | 183 | 181 | 183 | 183 | 183 | 276 | 205 |
| unevenness | | | | | | | | | | | | | | | | | |
| structure | | | | | | | | | | | | | | | | | |
| Aspect ratio | 1.0 | 1.0 | 1.0 | 1.0 | 1.0 | 1.1 | 1.0 | 1.0 | 1.0 | 1.0 | 1.0 | 1.0 | 1.0 | 1.0 | 1.0 | 1.6 | 1.4 |
| Specular | 0.2 | 0.2 | 0.2 | 0.2 | 0.4 | 0.2 | 0.2 | 0.2 | 0.3 | 0.2 | 0.2 | 0.3 | 0.2 | 0.2 | 0.2 | 0.2 | 0.2 |
| reflectance | | | | | | | | | | | | | | | | | |
| Cured film | B | B | B | C | B | A | B | B | B | B | B | B | A | B | B | D | B |
| strength | | | | | | | | | | | | | | | | | |
| Antifouling | A | A | A | A | A | A | A | A | A | A | A | A | A | B | A | B | D |
| property | | | | | | | | | | | | | | | | | |
| Water contact | 110 | 110 | 110 | 110 | 110 | 110 | 100 | 120 | 125 | 110 | 110 | 110 | 110 | 110 | 110 | 110 | 10 |
| angle | | | | | | | | | | | | | | | | | |
| Oleic acid | 75 | 75 | 75 | 75 | 75 | 75 | 60 | 80 | 85 | 75 | 65 | 60 | 75 | 75 | 75 | 75 | 1 |
| contact angle | | | | | | | | | | | | | | | | | |
| Fluorine | 3.3 | 3.3 | 3.3 | 3.3 | 3.3 | 3.3 | 0.8 | 5.0 | 6.0 | — | — | — | 3.3 | 3.3 | 3.3 | 3.3 | — |
| content(F/O) | | | | | | | | | | | | | | | | | |
| Silicon | — | — | — | — | — | — | — | — | — | 0.8 | 5.0 | 6.5 | — | — | — | — | — |
| content(Dsi/O) | | | | | | | | | | | | | | | | | |
| Remarks | Ex. | Ex. | Ex. | Ex. | Ex. | Ex. | Ex. | Ex. | Ex. | Ex. | Ex. | Ex. | Ex. | Ex. | Ex. | Ex. | Comp. |
| | | | | | | | | | | | | | | | | | Ex. |

Unlike in sample No. 101 of Comparative Example, it was found that the antifouling property required for practical use was achieved in the antireflection film of the present invention, in which the average aspect ratio of the unevenness structure is 1.0 or more, the contact angle of water is 100° or more, and the specular reflectance is 2.0% or less.

### Example 2

An appropriate of the curable composition A-1 in Example 1 above was collected and applied onto a triacetyl cellulose film (TD60UL, manufactured by Fujifilm Corporation) by a bar coater NO28 to have a uniform film thickness. Thereafter, a mold having a structure in which convex portions having an average height of 205 nm had been arranged with an average cycle of 180 nm on the surface thereof was bonded thereto. Confirming that the entire mold was bonded to the curable composition, the composition was polymerized by irradiating ultraviolet rays at 400 mJ/cm² using an UV irradiation device manufactured by Fusion Inc., and the mold was released to produce a moth-eye layer substrate film which has a moth-eye structure at an aspect ratio of 1.1 in which convex portions having an average height of 193 nm have an average cycle of 175 nm.

The reaction rate of the prepared moth-eye layer substrate film was 50%.

(Formation of antifouling layer 2)

A curable composition C-1 for an antifouling layer was coated on the antireflection film having the moth-eye structure by a die coater so that C-1 was layered on the moth-eye layer substrate film, and the projection amount was adjusted to have a film thickness of 0.5 nm. The composition was polymerized by irradiating UV rays at 800 mJ/cm² using an UV irradiation device manufactured by Fusion Inc to prepare the antifouling layer. That is, sample No. 17 was obtained.

Samples Nos. 18 to 34 and 102 were prepared in the same manner as in sample No. 17 except that in the preparation process for sample No. 17, the composition and constitution of a curable composition and a curable composition for an antifouling layer to be used were changed according to Table 3 below.

Sample No. 30 was obtained by coating a curable composition for an antifouling layer using a spray coating method instead of a die coater, Sample No. 31 was obtained using a dip coating method instead of a die coater, Sample No. 32 was obtained using an inkjet coating method instead of a die coater, and Sample No. 34 was obtained using a gravure coating method instead of a die coater.

In sample No. 33, a moth-eye structure was manufactured through bonding and polymerization in the same manner as in sample No. 17 except that as for the mold, a mold having a structure in which convex portions with an average height of 410 nm were arranged at an average cycle of 150 nm was used.

TABLE 3

| Sample No | 17 | 18 | 19 | 20 | 21 | 22 | 23 | 24 | 25 | 26 | 27 | 28 | 29 | 30 | 31 | 32 | 33 | 34 |
|---|---|---|---|---|---|---|---|---|---|---|---|---|---|---|---|---|---|---|
| Curable | A-11 | A-12 | A-13 | A-13 | A-13 | A-13 | A-13 | A-14 | A-15 | A-16 | A-13 | A-13 | A-13 | A-13 | A-13 | A-13 | A-11 | A-13 |
| composition | | | | | | | | | | | | | | | | | | |
| for moth eye | | | | | | | | | | | | | | | | | | |
| layer | | | | | | | | | | | | | | | | | | |
| Polyethylene | 55 | | | | | | | | | | | | | | | | 55 | |
| glycol | | | | | | | | | | | | | | | | | | |
| diacrylate(a) | | | | | | | | | | | | | | | | | | |
| Polyethylene | | 66 | 58 | 58 | 58 | 58 | 58 | 55 | | 55 | 58 | 58 | 58 | 58 | 58 | 58 | | 58 |
| glycol | | | | | | | | | | | | | | | | | | |
| diacrylate(b) | | | | | | | | | | | | | | | | | | |
| Polyethylene | | | | | | | | | 55 | | | | | | | | | |
| glycol | | | | | | | | | | | | | | | | | | |
| diacrylate(c) | | | | | | | | | | | | | | | | | | |
| Urethane | 40 | 29 | 34 | 34 | 34 | 34 | 34 | 40 | 40 | | 34 | 34 | 34 | 34 | 34 | 34 | 40 | 34 |
| acrylate(a) | | | | | | | | | | | | | | | | | | |
| Urethane | | | 3 | 3 | 3 | 3 | 3 | | | 40 | 3 | 3 | 3 | 3 | 3 | 3 | | 3 |
| acrylate(b) | | | | | | | | | | | | | | | | | | |
| 1-hydroxy- | 5 | 5 | 5 | 5 | 5 | 5 | 5 | 5 | 5 | 5 | 5 | 5 | 5 | 5 | 5 | 5 | 5 | 5 |
| cyclohexyl- | | | | | | | | | | | | | | | | | | |
| phenyl | | | | | | | | | | | | | | | | | | |
| ketone | | | | | | | | | | | | | | | | | | |
| Fluorine- | | | | | | | | | | | | | | | | | | |
| based | | | | | | | | | | | | | | | | | | |
| surfactant(a) | | | | | | | | | | | | | | | | | | |
| Curable | C-1 | C-1 | C-1 | C-2 | C-3 | C-4 | C-5 | C-1 | C-1 | C-1 | C-6 | C-7 | C-8 | C-1 | C-1 | C-1 | C-1 | C-1 |
| composition | | | | | | | | | | | | | | | | | | |
| for | | | | | | | | | | | | | | | | | | |
| antifouling | | | | | | | | | | | | | | | | | | |
| layer | | | | | | | | | | | | | | | | | | |
| Urethane | 90.0 | 90.0 | 90.0 | 94.5 | 88.0 | 90.0 | 90.0 | 90.0 | 90.0 | 90.0 | 90.0 | 93.5 | 80.0 | 90.0 | 90.0 | 90.0 | 90.0 | 90.0 |
| acrylate(a) | | | | | | | | | | | | | | | | | | |
| 1-hydroxy- | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 | 5.0 |
| cyclohexyl- | | | | | | | | | | | | | | | | | | |
| phenyl | | | | | | | | | | | | | | | | | | |
| ketone | | | | | | | | | | | | | | | | | | |
| Fluorine- | 5.0 | 5.0 | 5.0 | 0.5 | 7.0 | | | 5.0 | 5.0 | 5.0 | | | | 5.0 | 5.0 | 5.0 | 5.0 | 5.0 |
| based | | | | | | | | | | | | | | | | | | |
| surfactant(a) | | | | | | | | | | | | | | | | | | |
| Fluorine- | | | | | | 5.0 | | | | | | | | | | | | |
| based | | | | | | | | | | | | | | | | | | |
| surfactant(b) | | | | | | | | | | | | | | | | | | |
| Fluorine- | | | | | | | 5.0 | | | | | | | | | | | |
| based | | | | | | | | | | | | | | | | | | |
| surfactant(c) | | | | | | | | | | | | | | | | | | |
| XX-24-174DX | | | | | | | | | | | 5.0 | 1.5 | 15.0 | | | | | |
| Remarks | Ex. | Ex. | Ex. | Ex. | Ex. | Ex. | Ex. | Ex. | Ex. | Ex. | Ex. | Ex. | Ex. | Ex. | Ex. | Ex. | Ex. | Ex. |

TABLE 4

| Sample No. | 17 | 18 | 19 | 20 | 21 | 22 | 23 | 24 | 25 | 26 | 27 | 28 | 29 | 30 | 31 | 31 | 33 | 34 |
|---|---|---|---|---|---|---|---|---|---|---|---|---|---|---|---|---|---|---|
| Curable | A-11 | A-12 | A-13 | A-13 | A-13 | A-13 | A-13 | A-14 | A-15 | A-16 | A-13 | A-13 | A-13 | A-13 | A-13 | A-13 | A-11 | A-13 |
| composition | | | | | | | | | | | | | | | | | | |
| for moth eye | | | | | | | | | | | | | | | | | | |
| layer | | | | | | | | | | | | | | | | | | |
| Curable | C-1 | C-1 | C-1 | C-2 | C-3 | C4 | C-5 | C-1 | C-1 | C-1 | C-6 | C-7 | C-8 | C-1 | C-1 | C-1 | C-1 | C-1 |
| composition | | | | | | | | | | | | | | | | | | |
| for antifouling | | | | | | | | | | | | | | | | | | |
| layer | | | | | | | | | | | | | | | | | | |
| Cycle of | 175 | 175 | 175 | 175 | 175 | 175 | 175 | 175 | 175 | 175 | 175 | 175 | 175 | 175 | 175 | 175 | 175 | 175 |
| unevenness | | | | | | | | | | | | | | | | | | |
| structure | | | | | | | | | | | | | | | | | | |
| Height/depth | 183 | 183 | 183 | 183 | 183 | 183 | 183 | 183 | 183 | 183 | 183 | 183 | 183 | 183 | 175 | 183 | 276 | 167 |
| of unevenness | | | | | | | | | | | | | | | | | | |
| structure | | | | | | | | | | | | | | | | | | |
| Aspect ratio | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | 1.0 | 1.6 | 1.0 |
| Specular | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.2 | 0.4 |
| reflectance | | | | | | | | | | | | | | | | | | |
| Cured film | B | B | B | B | C | B | A | B | B | B | B | B | C | B | B | B | D | B |
| strength | | | | | | | | | | | | | | | | | | |
| Antifouling | A | A | A | B | A | A | B | A | A | A | A | C | A | A | A | A | A | A |
| property | | | | | | | | | | | | | | | | | | |
| Contact angle | 110 | 110 | 110 | 105 | 115 | 120 | 130 | 110 | 110 | 110 | 110 | 105 | 115 | 110 | 110 | 110 | 110 | 110 |
| water | | | | | | | | | | | | | | | | | | |
| Contact angle | 75 | 75 | 75 | 70 | 78 | 80 | 90 | 75 | 75 | 75 | 70 | 65 | 75 | 75 | 75 | 75 | 75 | 75 |
| oleic acid | | | | | | | | | | | | | | | | | | |
| Fluorine | 0.9 | 0.9 | 0.9 | 0.1 | 1.5 | 0.8 | 1.0 | 0.9 | 0.9 | 0.9 | — | — | — | 0.9 | 0.9 | 0.9 | 0.9 | 0.8 |
| content (F/O) | | | | | | | | | | | | | | | | | | |
| Silicon | | | | | | | | | | | | | | | | | | |
| content | — | — | — | — | — | — | — | — | — | — | 0.3 | 0.1 | 1.1 | — | — | — | — | — |
| (Dsi/O) | | | | | | | | | | | | | | | | | | |
| Remark | Ex. | Ex. | Ex. | Ex. | Ex. | Ex. | Ex. | Ex. | Ex. | Ex. | Ex. | Ex. | Ex. | Ex. | Ex. | Ex. | Ex. | Ex. |

Unlike in sample No. 102 of Comparative Example, it was found that the antifouling property required for practical use was improved in the antireflection film of the present invention, in which the average aspect ratio of the unevenness structure is 1.0 or more, the water contact angle is 100° or more, and the specular reflectance is 2.0% or less.

Also, when the antifouling layer was formed by a die coater, a spray coating method, a dip coating method, and an inkjet coating method in the present invention, it was found that the reflectance, hardness, and antifouling property were improved without damage to the moth eye unevenness structure unlike in sample No. 25 of Comparative Example manufactured by a gravure method.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. An antireflection film comprising:
an unevenness structure having an average cycle ranging from 50 nm to 400 nm in at least one certain direction, and
an antifouling layer in a region of the unevenness structure located in a range of 0.1 nm to 5 nm from an unevenness structure surface toward the transparent substrate film side,
wherein in the unevenness structure, an average aspect ratio of an average height of convex portions or an average depth of concave portions to an average cycle is from 1.0 to 3.0,
a water contact angle to the unevenness structure surface is 110° or more, and
a specular reflectance is 2.0% or less, and
wherein a content ratio of fluorine atoms to oxygen atoms in the antifouling layer is from 1.0 to 5.0, or a content ratio of silicon atoms derived from a silicone structure to oxygen atoms in the antifouling layer is from 1.0 to 5.0.

2. The antireflection film according to claim 1, further comprising silica fine particles on the unevenness structure surface, in which a modification rate of a hydrophobic modification is 30% or less, and an average primary particle diameter is 20 nm or less.

3. A kit comprising:
an antireflection film according to claim 1; and
a cleaning cloth having a void or hole with a smaller interval than an average cycle of an unevenness structure of the antireflection film according to claim 1, in which a water contact angle of the cleaning cloth is less than 90°.
